(19) United States
(12) Patent Application Publication
(10) Pub. No.: US 2025/0038257 A1
(43) Pub. Date: Jan. 30, 2025

(54) SECONDARY BATTERY, BATTERY PACK, AND VEHICLE

(71) Applicant: KABUSHIKI KAISHA TOSHIBA, Tokyo (JP)

(72) Inventors: Yuiko KOITABASHI, Yokohama (JP); Sayaka MORIMOTO, Kawasaki (JP); Asato KONDO, Yokohama (JP); Tetsuya SASAKAWA, Yokohama (JP)

(73) Assignee: KABUSHIKI KAISHA TOSHIBA, Tokyo (JP)

(21) Appl. No.: 18/442,196

(22) Filed: Feb. 15, 2024

(30) Foreign Application Priority Data
Jul. 25, 2023 (JP) 2023-120875

(51) Int. Cl. H01M 10/0567; H01M 4/02; H01M 4/04; H01M 4/485; H01M 4/505; H01M 4/525; H01M 4/62; H01M 4/66; H01M 10/0568

(52) U.S. Cl. CPC H01M 10/0567; H01M 4/0404; H01M 4/485; H01M 4/505; H01M 4/525; H01M 4/623; H01M 4/661; H01M 10/0568; H01M 2004/027; H01M 2004/028

(57) ABSTRACT

In general, according to one embodiment, a secondary battery including a positive electrode, a negative electrode, and a nonaqueous electrolyte is provided. The positive electrode includes a positive electrode mixture layer containing a positive electrode active material and sulfur atoms. A mass of sulfur atoms per unit volume of the positive electrode mixture layer is 430 g/m³ or less. The nonaqueous electrolyte contains propanesultone and lithium difluorophosphate. A concentration of the propanesultone in the nonaqueous electrolyte is 0.5% by mass or more. A concentration of the lithium difluorophosphate in the nonaqueous electrolyte is 0.2% by mass or more.

### CROSS-REFERENCE TO RELATED APPLICATIONS

This application is based upon and claims the benefit of priority from Japanese Patent Application No. 2023-120875, filed Jul. 25, 2023, the entire contents of which are incorporated herein by reference.

### FIELD

Embodiments described herein relate generally to a secondary battery, a battery pack, and a vehicle.

### BACKGROUND

Secondary batteries containing nonaqueous electrolytes have problems with output performance and high-temperature durability. One reason for this is gas generation due to the reaction between the nonaqueous electrolyte and the electrode react with each other to cause gas generation. When gas generation occurs, air bubbles are generated inside the electrode, which can easily cause exfoliation of the active material, increase the resistance, and deteriorate the output performance. Secondary batteries containing nonaqueous electrolytes are prone to cause gas generation, especially in high-temperature environments.

### BRIEF DESCRIPTION OF DRAWINGS

FIG. 1 is a cross-sectional view of a secondary battery according to an embodiment, taken perpendicularly to an extending direction of a terminal.

FIG. 2 is an enlarged cross-sectional view of the portion A shown in FIG. 1.

FIG. 3 is a partially cut-out cross-sectional view of the secondary battery according to the embodiment.

FIG. 4 is a side view of the battery shown in FIG. 3.

FIG. 5 is a partially cutaway perspective view schematically showing another example of the secondary battery according to the embodiment.

FIG. 6 is an enlarged cross-sectional view of the portion B of the secondary battery shown in FIG. 5.

FIG. 7 is a schematic plan view showing an example of a method of producing the secondary battery of the embodiment.

FIG. 8 is an exploded perspective view of a battery pack according to an embodiment.

FIG. 9 is a block diagram showing an electric circuit of the battery pack shown in FIG. 8.

FIG. 10 is a schematic view showing an example of a vehicle including the secondary battery of the embodiment.

FIG. 11 is a diagram schematically showing another example of the vehicle according to the embodiment.

### DETAILED DESCRIPTION

In general, according to one embodiment, a secondary battery including a positive electrode, a negative electrode, and a nonaqueous electrolyte is provided. The positive electrode includes a positive electrode mixture layer containing a positive electrode active material and sulfur atoms. A mass of sulfur atoms per unit volume of the positive electrode mixture layer is 430 g/m³ or less. The nonaqueous electrolyte contains propanesultone and lithium difluorophosphate. A concentration of the propanesultone in the nonaqueous electrolyte is 0.5% by mass or more. A concentration of the lithium difluorophosphate in the nonaqueous electrolyte is 0.2% by mass or more.

According to another embodiment, a battery pack including the secondary battery of the embodiment is provided.

According to another embodiment, a vehicle including the battery pack of the embodiment is provided.

### First Embodiment

According to a first embodiment, a secondary battery including a positive electrode, a negative electrode, and a nonaqueous electrolyte is provided. The positive electrode includes a positive electrode mixture layer containing a positive electrode active material and sulfur atoms. The mass of sulfur atoms per unit volume of the positive electrode mixture layer is 430 g/m³ or less. The nonaqueous electrolyte contains propanesultone and lithium difluorophosphate. The concentration of propanesultone in the nonaqueous electrolyte is 0.5% by mass or more. The concentration of lithium difluorophosphate in the nonaqueous electrolyte is 0.2% by mass or more.

As a result of intensive studies, the present inventors have found that the addition of propanesultone (PS; 1,3-propanesultone) to the nonaqueous electrolyte can improve the high-temperature durability of the secondary battery. The mechanism therefor is assumed to be as follows.

When the nonaqueous electrolyte and the positive electrode active material in the positive electrode come into contact with each other at a high temperature, especially under high temperature and high state of charge (SOC) conditions, oxidative decomposition of the nonaqueous electrolyte occurs, and gas generation occurs.

The secondary battery according to the embodiment contains propanesultone in a nonaqueous electrolyte. When propanesultone reacts with the positive electrode active material, it decomposes to form a sulfur-containing phase containing sulfur atoms. Therefore, the positive electrode mixture layer contains sulfur atoms in addition to the positive electrode active material. The fact that the mass of sulfur atoms per unit volume of the positive electrode mixture layer is 430 g/m³ or less means that the amount of the sulfur-containing phase is not excessively large with respect to the positive electrode mixture layer. This can suppress resistance increase, and thus keeps high output performance of the positive electrode.

When propanesultone is present in the nonaqueous electrolyte, the reaction in which propanesultone reacts with and decomposes the positive electrode active material in the positive electrode is more likely to proceed than the reaction between components other than propanesultone in the nonaqueous electrolyte and the positive electrode active material. In addition, no gas is generated in the decomposition reaction of propanesultone. That is, propanesultone as a sacrificial material is decomposed in preference to other nonaqueous electrolyte components, thereby suppressing gas generation due to oxidative decomposition of the nonaqueous electrolyte. Therefore, gas generation due to oxidative decomposition of the nonaqueous electrolyte can be suppressed even at a high temperature. This suppresses resistance increase due to generation of air bubbles in the positive electrode. As a result, output performance and high-temperature durability can be improved.

In order for propanesultone to serve as a sacrificial material, propanesultone needs to be present in the nonaqueous electrolyte. However, even when propanesultone is added in preparing the nonaqueous electrolyte, propanesultone is easily decomposed at the time of initial charging-discharging of the secondary battery. Therefore, it is difficult to maintain the presence of propanesultone in the nonaqueous electrolyte after the first charging-discharging, for example, during storage or a charge and discharge cycle.

The nonaqueous electrolyte contained in the secondary battery according to the embodiment contains lithium difluorophosphate (DFP:LiPO₂F₂) in addition to propanesultone. In the nonaqueous electrolyte, the reaction in which lithium difluorophosphate is consumed is more likely to proceed than the reaction between the positive electrode active material and propanesultone. Therefore, the inclusion of lithium difluorophosphate in the nonaqueous electrolyte can suppress decomposition of propanesultone.

In the nonaqueous electrolyte contained in the secondary battery according to the embodiment, since the concentration of lithium difluorophosphate is 0.2% by mass or more, the effect of suppressing decomposition of propanesultone is easily obtained. Therefore, even after the first charging-discharging of the secondary battery, the presence of propanesultone in the nonaqueous electrolyte can be easily maintained.

In the nonaqueous electrolyte contained in the secondary battery according to the embodiment, the concentration of propanesultone is 0.5% by mass or more. That is, propanesultone is present in the nonaqueous electrolyte to such an extent that propanesultone can sufficiently serve as a sacrificial material. As a result, gas generation due to oxidative decomposition of the nonaqueous electrolyte can be suppressed.

Therefore, according to the embodiment, a secondary battery having high output performance and high high-temperature durability can be provided.

The secondary battery according to the embodiment will be described in more detail with reference to the drawings.

The secondary battery may be, for example, a secondary battery including alkali metal ions as carrier ions. For example, it may be a lithium battery (lithium-ion battery).

The lower limit value of the mass of sulfur atoms per unit volume of the positive electrode mixture layer may be, for example, 20 g/m³. The mass of sulfur atoms per unit volume of the positive electrode mixture layer is preferably in a range of 100 g/m³ to 420 g/m³, and more preferably in a range of 350 g/m³ to 410 g/m³. The mass of sulfur atoms per unit volume of the positive electrode mixture layer may be, for example, 390 g/m³ or more. When the amount of the sulfur-containing phase is high with respect to the positive electrode mixture layer, the mass of sulfur atoms per unit volume of the positive electrode mixture layer may be higher. Therefore, when the mass of sulfur atoms per unit volume of the positive electrode mixture layer is high, contact between the positive electrode mixture layer and the nonaqueous electrolyte is unlikely to occur, so that gas generation can be suppressed.

The negative electrode included in the secondary battery according to the embodiment may include a negative electrode mixture layer. The negative electrode mixture layer preferably further contains sulfur atoms in addition to the negative electrode active material.

Propanesultone can also form a sulfur-containing phase when reacted with the negative electrode active material. Therefore, the negative electrode mixture layer may contain sulfur atoms in addition to the negative electrode active material.

In the electrode containing the sulfur-containing phase, contact between the nonaqueous electrolyte and the active material contained in the electrode may be less likely to occur. In general, at the time of assembling the secondary battery, water (H₂O) may be brought in as an inevitable impurity. The water brought into the secondary battery may react with the nonaqueous electrolyte to generate hydrofluoric acid (hydrogen fluoride, HF) in the nonaqueous electrolyte. Contact between hydrofluoric acid in the nonaqueous electrolyte and the electrode is not preferable because it can deteriorate the active material.

Therefore, the inclusion of sulfur atoms in the negative electrode mixture layer in addition to the negative electrode active material is preferable because it prevents contact between the negative electrode active material and the nonaqueous electrolyte, thereby suppressing deterioration of the negative electrode active material.

The mass of sulfur atoms per unit volume of the negative electrode mixture layer is preferably 430 g/m³ or less. The fact that the mass is within the above numerical range means that the amount of the sulfur-containing phase is not too much with respect to the negative electrode mixture layer. This suppresses resistance increase, and thus can keep high output performance of the negative electrode.

The lower limit value of the mass of sulfur atoms per unit volume of the negative electrode mixture layer may be, for example, 20 g/m³. The mass of sulfur atoms per unit volume of the negative electrode mixture layer is preferably in a range of 100 g/m³ to 420 g/m³, and more preferably in a range of 350 g/m³ to 410 g/m³. The mass of sulfur atoms per unit volume of the negative electrode mixture layer may be, for example, 380 g/m³ or more. When the amount of the sulfur-containing phase is high with respect to the negative electrode mixture layer, the mass of sulfur atoms per unit volume of the negative electrode mixture layer may be higher. Therefore, when the amount of sulfur atoms per unit volume of the negative electrode mixture layer is high, contact between the negative electrode active material and the nonaqueous electrolyte is less likely to occur, so that deterioration of the negative electrode active material can be suppressed.

As a result of decomposition of propanesultone, each of the positive electrode mixture layer which may be included in the positive electrode and the negative electrode mixture layer which may be included in the negative electrode (electrode mixture layer) may include a sulfur-containing phase containing sulfur atoms. The sulfur atoms may be derived from a decomposition product of the nonaqueous electrolyte. In addition, the sulfur atom can be derived from a decomposition product of propanesultone contained in the nonaqueous electrolyte. The sulfur-containing phase can be formed on the active material in the electrode mixture layer. The sulfur-containing phase may be a layer formed on the active material, or may be a film covering at least a part of the surface of the active material particle. The sulfur-containing phase may contain other kinds of atoms in addition to sulfur atoms (S). Examples of other kinds of atoms include oxygen atoms (O) and carbon atoms (C).

The electrode mixture layer may include an active material-containing layer containing an active material and a sulfur-containing phase formed on at least a part of the active material. Here, the active material-containing layer refers to a layer included in the electrode mixture layer, which is formed on a current collector and contains an active material. The sulfur-containing phase may be formed, for example, on at least a part of the active material-containing layer or on at least a part of the surface of the active material-containing layer. The sulfur-containing phase that can be included in the positive electrode mixture layer and the negative electrode mixture layer may be described as a positive electrode sulfur-containing phase and a negative electrode sulfur-containing phase, respectively.

The upper limit value of the concentration of propanesultone in the nonaqueous electrolyte may be 5% by mass, but the upper limit value may also be, for example, 5.0% by mass. The concentration of propanesultone is preferably in a range of 0.55% by mass to 4.8% by mass, and more preferably in a range of 0.6% by mass to 4.6% by mass. The concentration of propanesultone in the nonaqueous electrolyte may be, for example, 4.50% by mass or less. An excessively high concentration of propanesultone is not preferable because it may lead to excessive formation of decomposition products of propanesultone in the electrode mixture layer and cause resistance increase.

The concentration of propanesultone in the nonaqueous electrolyte may be 0.50% by mass or more.

The upper limit value of the concentration of lithium difluorophosphate in the nonaqueous electrolyte may be 5% by mass, but the upper limit value may also be, for example, 5.0% by mass. The concentration of lithium difluorophosphate is preferably in a range of 0.55% by mass to 4.8% by mass, and more preferably in a range of 0.6% by mass to 4.6% by mass. The concentration of lithium difluorophosphate in the nonaqueous electrolyte may also be, for example, 4.50% by mass or less. An excessively high concentration of lithium difluorophosphate is not preferable because it may lead to precipitation of lithium difluorophosphate in the nonaqueous electrolyte.

The concentration of lithium difluorophosphate in the nonaqueous electrolyte may be 0.20% by mass or more.

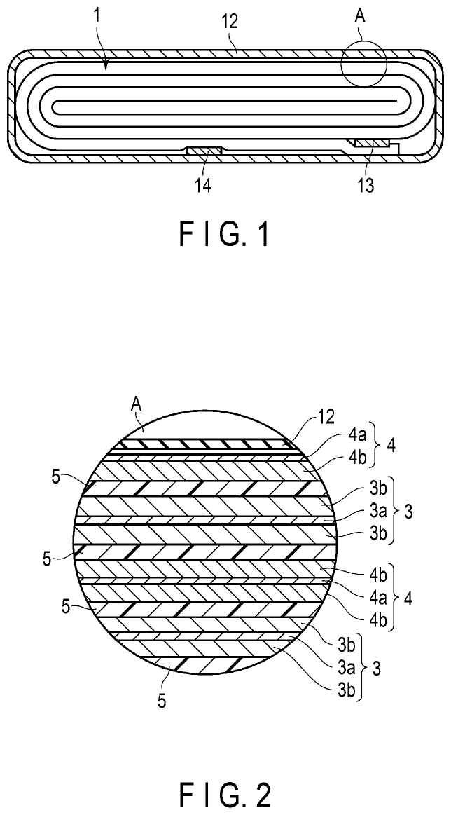

FIGS. 1 and 2 show an example of a secondary battery which uses a container member made of a laminated film.

As shown in FIGS. 1 and 2, an electrode group 1 is a flat wound electrode group. The wound electrode group 1 is housed in a bag-form container member 12 made of a laminated film including two resin films and a metal layer interposed therebetween. The flat wound electrode group 1 is formed by spirally winding a stack obtained by stacking a negative electrode 4, a separator 5, a positive electrode 3, and a separator 5 in the mentioned order from the outer side, about an axis parallel to the short-side direction of the stack, and then press-forming the wound stack. The negative electrode 4 at the outermost layer has a structure in which a negative electrode layer (negative electrode mixture layer) 4b containing a negative electrode active material is formed on one surface of a negative electrode current collector 4a that is on the internal surface side, as shown in FIG. 2; and the other portions of the negative electrode 4 have a structure in which the negative electrode layer 4b is formed on both surfaces of the negative electrode current collector 4a. The positive electrode 3 is configured so that a positive electrode layer (positive electrode mixture layer) 3b is formed on both surfaces of a positive electrode current collector 3a.

In the vicinity of the outer peripheral edge of the wound electrode group 1, a negative electrode terminal 13 is connected to the negative electrode current collector 4a of the negative electrode 4 at the outermost layer, and a positive electrode terminal 14 is connected to the positive electrode current collector 3a of the positive electrode 3 on the inner side. The negative electrode terminal 13 and the positive electrode terminal 14 are extended out from an opening of the bag-form container member 12. The wound electrode group 1 is sealed by heat-sealing the opening of the bag-form container member 12. When heat-sealing the opening of the bag-form container member 12, the negative electrode terminal 13 and the positive electrode terminal 14 are held by the bag-form container member 12 at the opening thereof.

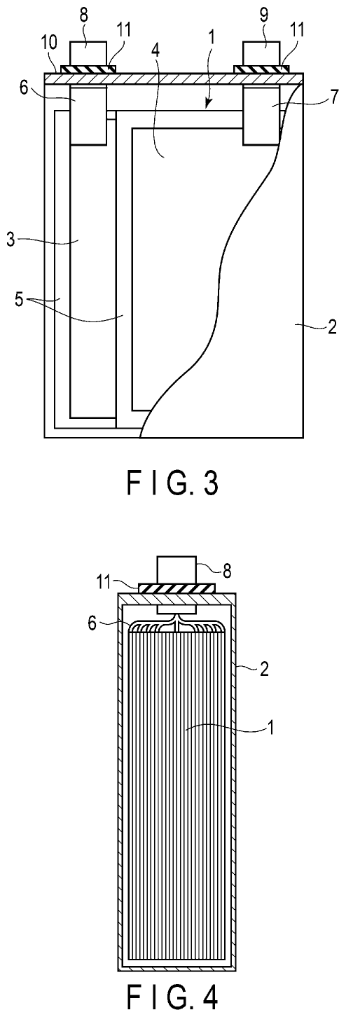

FIGS. 3 and 4 show an example of a secondary battery which uses a metallic container.

An electrode group 1 is housed in a metallic container 2 having a rectangular tubular shape. The electrode group 1 is formed by, for example, interposing the separator 5 between the positive electrode 3 and the negative electrode 4 and winding the stack of the positive electrode 3, the separator 5 and the negative electrode 4 into a flat spiral shape about an axis parallel to the short-side direction of the stack. As shown in FIG. 4, strip-shaped positive electrode leads 6 are electrically connected to multiple portions of an edge of the positive electrode 3, respectively, that is positioned on an end face of the electrode group 1 intersecting with the stacking direction of the electrode. Strip-shaped negative electrode leads 7 are also electrically connected to multiple portions of an edge of the negative electrode 4, respectively, that is positioned on said end face. A bundle of the positive electrode leads 6 is electrically connected to a positive electrode current collecting tab 8. A positive electrode terminal is formed of the positive electrode leads 6 and the positive electrode current collecting tab 8. A bundle of negative electrode leads 7 are connected to a negative electrode current collecting tab 9. A negative electrode terminal is formed of the negative electrode leads 7 and the negative electrode current collecting tab 9. A sealing plate 10 made of metal is fixed to an opening of the metallic container 2 by welding or the like. The positive electrode current collecting tab 8 and the negative electrode current collecting tab 9 are respectively drawn out from outlet holes provided in the sealing plate 10. The inner peripheral surface of each outlet hole of the sealing plate 10 is coated with an insulating member 11 in order to prevent a short circuit from occurring due to a contact between the positive electrode current collecting tab 8 and the negative electrode current collecting tab 9.

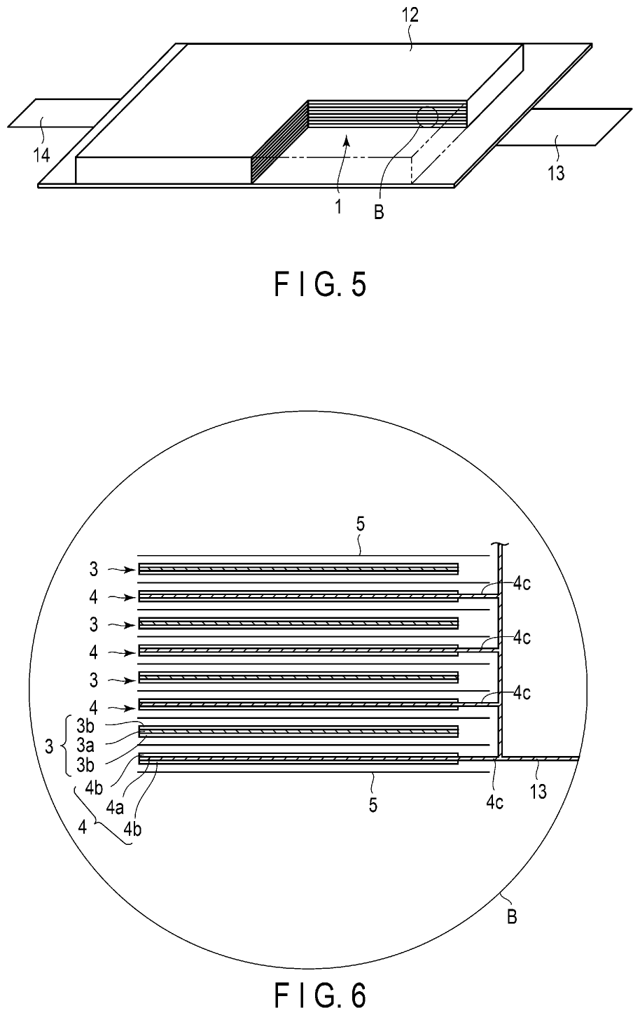

The secondary battery according to the embodiment is not limited to the secondary battery having the configuration shown in FIGS. 1 and 2 and the secondary battery having the configuration shown in FIGS. 3 and 4, and may be, for example, a battery having the configuration shown in FIGS. 5 and 6.

FIG. 5 is a partially cutaway perspective view schematically showing another example of the secondary battery. FIG. 6 is an enlarged cross-sectional view of the portion B of the secondary battery shown in FIG. 5.

The secondary battery shown in FIGS. 5 and 6 includes an electrode group 1 shown in FIGS. 5 and 6, a container member 12 shown in FIG. 5, and an electrolyte (not shown). The electrode group 1 and the electrolyte are housed in the container member 12. The electrolyte is held in the electrode group 1.

The container member 12 is made of a laminated film including two resin layers and a metal layer interposed therebetween.

As shown in FIG. 6, the electrode group 1 is a stacked electrode group. The stacked electrode group 1 has a structure in which negative electrodes 4 and positive electrodes 3 are alternately laminated with a separator 5 interposed between each.

The electrode group 1 includes a plurality of negative electrodes 4. Each of the plurality of negative electrodes 4 includes a negative electrode current collector 4a and a negative electrode active material-containing layer 4b supported on both surfaces of the negative electrode current collector 4a. The electrode group 1 also includes a plurality of positive electrodes 3. Each of the plurality of positive electrodes 3 includes a positive electrode current collector 3a and a positive electrode active material-containing layer 3b supported on both surfaces of the positive electrode current collector 3a.

The negative electrode current collector 4a of each of the negative electrodes 4 includes a portion on one of its sides where the negative electrode active material-containing layer 4b is not supported on any surface. This portion serves as a negative electrode current-collecting tab 4c. As shown in FIG. 6, the negative electrode current-collecting tab 4c does not overlap the positive electrode 3. The plurality of negative electrode current-collecting tabs 4c are electrically connected to a belt-shaped negative electrode terminal 13. The tip of the belt-shaped negative electrode terminal 13 is drawn out to the outside of the container member 12.

Although not shown, the positive electrode current collector 3a of each positive electrode 3 includes a portion on one of its sides where the positive electrode active material-containing layer 3b is not supported on any surface. This portion serves as a positive electrode current-collecting tab. Like the negative electrode current-collecting tab 4c, the positive electrode current-collecting tab does not overlap with the negative electrode 4. The positive electrode current-collecting tab is located on the opposite side of the electrode group 1 with respect to the negative electrode current-collecting tab 4c. The positive electrode current-collecting tab is electrically connected to the belt-shaped positive electrode terminal 14. The tip of the belt-shaped positive electrode terminal 14 is located on the side opposite to the negative electrode terminal 13 and is drawn out to the outside of the container member 12.

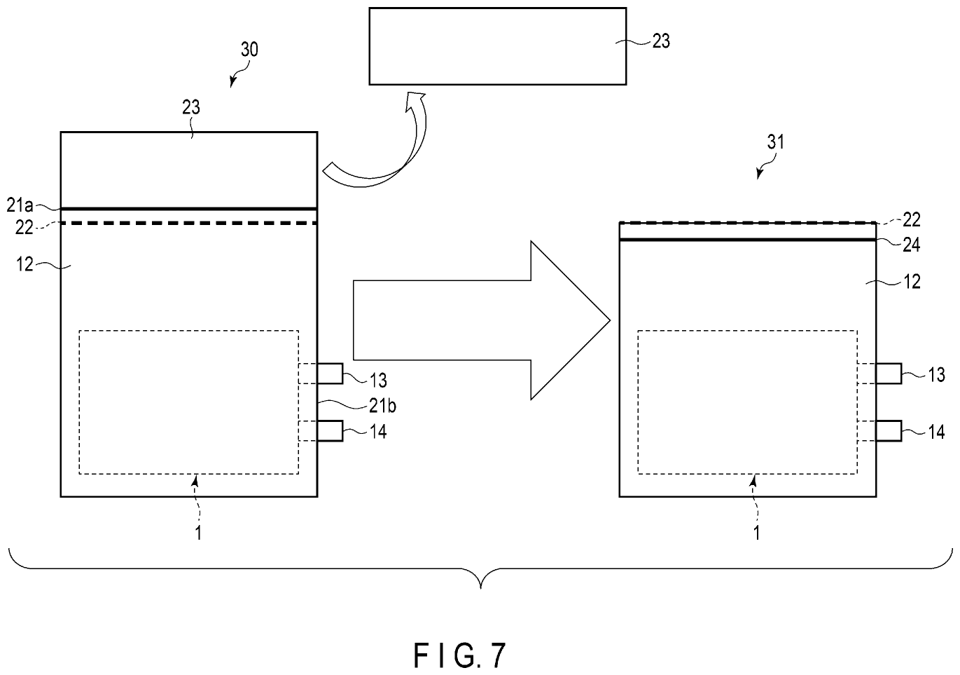

As an example of the secondary battery of the embodiment, a method for producing a secondary battery including a wound electrode group will be described with reference to FIG. 7. FIG. 7 is a schematic diagram illustrating an outline of a method of producing a secondary battery which uses a bag-form container member made of a laminated film.

First, the positive electrode 3 and the negative electrode 4 are produced.

To produce the positive electrode, for example, the positive electrode active material, the conductive agent, and the binder are suspended in a solvent to prepare a slurry. The slurry is applied to either one or both surfaces of the current collector. The applied slurry is then dried to obtain a stack of the positive electrode active material-containing layer and the current collector. Thereafter, the stack is pressed. The positive electrode is thus produced. Alternatively, the positive electrode may be produced by the following method. First, the active material, the conductive agent, and the binder are mixed to obtain a mixture. Next, the mixture is formed into pellets. These pellets are then arranged on the current collector, whereby the positive electrode can be obtained.

The negative electrode can be produced, for example, by the following method. First, the negative electrode active material, the conductive agent, and the binder are suspended in a solvent to prepare a slurry. The slurry is applied to either one or both surfaces of the current collector. The applied slurry is then dried to obtain a stack of the negative electrode active material-containing layer and the current collector. Thereafter, the stack is pressed. The negative electrode is thus produced. Alternatively, the negative electrode may be produced by the following method. First, the negative electrode active material, the conductive agent, and the binder are mixed to obtain a mixture. Next, the mixture is formed into pellets. These pellets are then arranged on the current collector, whereby the negative electrode can be obtained.

The separator 5 is arranged between the positive electrode 3 and the negative electrode 4 to produce the electrode group 1. The positive electrode terminal 14 is electrically connected to the positive electrode 3 of the electrode group 1, and the negative electrode terminal 13 is electrically connected to the negative electrode 4 of the electrode group 1.

After the electrode group 1 having the positive and negative electrode terminals 13 and 14 are housed in the bag-form container member 12 made of a laminated film, an edge 21b, excluding a first edge 21a, is heat-sealed. Next, the nonaqueous electrolyte is poured into the bag-form container member 12 from the first edge 21a, and the first edge 21a is heat-sealed. The heat sealing may be performed under reduced pressure. Through this procedure, a secondary battery 30 subjected to the first sealing is obtained.

The secondary battery 30 subjected to the first sealing is then subjected to initial charging-discharging at an ambient temperature (e.g., 25° C.), followed by aging at a temperature equal to or greater than the ambient temperature. By undergoing the initial charging-discharging and aging, a reaction between propanesultone and the positive electrode active material occurs, and as a result, sulfur atoms are contained in the positive electrode active material-containing layer. Specifically, a decomposition product of the nonaqueous electrolyte containing propanesultone can be formed on the surface of the positive electrode active material contained in the positive electrode active material-containing layer. As a result, a layered sulfur-containing phase can be formed on the surface of the positive electrode active material. In this way, the positive electrode mixture layer 3b containing sulfur atoms can be obtained. At this time, sulfur atoms may also be contained in the negative electrode active material-containing layer. As a result, the negative electrode mixture layer 4b containing sulfur atoms can be obtained.

After the aging, the temperature of the secondary battery 30 is returned to an ambient temperature, and then an unsealed portion of the bag-form container member 12 is cut along a section line 22 on an inner side relative to the first edge 21a to open the bag-form container member 12 in an argon atmosphere, thereby releasing the gas inside the bag-form container member 12 to the outside. The portion cut out from the bag-form container member 12 along the section line 22 is indicated by a reference numeral “23”.

Next, an edge 24 along the section line 22 is sealed under reduced pressure (for example, −90 kPa).

By adjusting the production conditions of the production method described above, the mass of sulfur atoms per unit volume of the positive electrode mixture layer and the concentration of propanesultone and the concentration of lithium difluorophosphate in the nonaqueous electrolyte can be set within the target ranges. Through this procedure, a secondary battery 31 of the embodiment is obtained.

Details of the production conditions will be described below.

The positive and negative electrodes used for producing the electrode group are preferably dried in advance before producing the electrode group. The higher the drying temperature and the longer the drying time, the less moisture remains in the electrodes. From the viewpoint of reducing moisture in the electrodes, drying is preferably performed under reduced pressure. For example, vacuum drying at 120° C. for 24 hours is preferable.

When the positive and negative electrodes are produced through a step of applying a slurry to one surface or both surfaces of a current collector and then drying the coating of the applied slurry, it is preferable to further perform the above drying after the coating drying step.

When the positive and negative electrodes used for producing the electrode group are dry, the amount of moisture brought into the secondary battery can be reduced. When moisture is brought into the secondary battery, water itself may be electrolyzed to cause gas generation, and a side reaction in the negative electrode is more likely to occur. Therefore, lithium ions released by the positive electrode in the battery reaction are consumed in the side reaction at the negative electrode and are less likely to be inserted into the negative electrode. As a result, SOC deviation may occur or the positive electrode potential may be shifted to the high potential side. When the positive electrode potential becomes too high and deviates from the potential range in which the nonaqueous electrolyte can stably exist, decomposition of the nonaqueous electrolyte easily occurs in the positive electrode, which causes gas generation. In addition, when moisture is brought into the secondary battery, the nonaqueous electrolyte and water react to generate hydrofluoric acid, which can deteriorate the electrodes.

In addition, lithium difluorophosphate can capture moisture brought into the secondary battery, but is consumed at this time. Therefore, when the amount of moisture brought into the secondary battery is high, lithium difluorophosphate is easily consumed, so that the effect of suppressing decomposition of propanesultone by lithium difluorophosphate may be difficult to obtain.

Therefore, the positive and negative electrodes used for producing the electrode group are preferably dry, because this can suppress side reactions and facilitate the remaining of lithium difluorophosphate and propanesultone in the nonaqueous electrolyte, thereby reducing gas generation in the secondary battery of the embodiment.

As described with reference to FIG. 7, when the first charging-discharging and aging are performed on the secondary battery 30 subjected to the first sealing, gas generation occurs in the secondary battery 30 subjected to the first sealing. Examples of the gas generation reaction include the reaction in which water brought into the secondary battery 30 is decomposed.

As described with reference to FIG. 7, the gas generated in the initial charging-discharging and aging is released to the outside after the aging. Therefore, the residual amount of the substance that causes gas generation in the secondary battery 31 of the embodiment obtained after aging can be reduced by actively promoting the gas generation reaction during aging. Therefore, gas generation in the secondary battery 31 of the embodiment can be suppressed.

The higher the aging temperature and the longer the aging time, the more easily the gas generation reaction in aging can proceed.

The lower the aging temperature, the less propanesultone is decomposed and consumed during aging, thereby increasing the amount of propanesultone remaining in the nonaqueous electrolyte of the secondary battery 31 of the embodiment.

The aging temperature is preferably a low temperature of 25° C. to 50° C. The aging time is preferably a long time of 30 hours to 48 hours.

In order to leave propanesultone in the secondary battery 31 of the embodiment and to suppress gas generation in the secondary battery 31 of the embodiment, aging is preferably performed at a low temperature for a long time.

Hereinafter, the positive electrode, the negative electrode, and the nonaqueous electrolyte will be described. A separator and a container member that may be included in the secondary battery of the embodiment in addition to these members will also be described below.

### 1) Positive Electrode

The positive electrode may include a positive electrode current collector and a positive electrode mixture layer. The positive electrode mixture layer may be formed on one side or both sides of the positive electrode current collector. The positive electrode mixture layer may contain a positive electrode active material, sulfur atoms, and optionally a conductive agent and a binder. The positive electrode mixture layer may include the positive electrode sulfur-containing phase described above. The sulfur atoms may be contained in the positive electrode sulfur-containing phase. The positive electrode sulfur-containing phase may be present on at least a part of the surface of the positive electrode, or may cover at least a part of the surface of the positive electrode active material particles. The positive electrode sulfur-containing phase may have a film shape or a layered shape.

For example, an oxide or a sulfide may be used as the positive electrode active material. The positive electrode may include, as the positive electrode active material, one kind of compound alone or two or more kinds of compounds in combination. Examples of the oxide and sulfide include compounds that allow Li or Li ions to be inserted thereinto and extracted therefrom.

Examples of such compounds include manganese dioxide (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphorus oxides having an olivine structure (e.g., LiₓFePO₄; 0<x≤1, LiₓFe_{1-y}Mn_{y}PO₄; 0<x≤1, 0<y≤1, and LiₓCoPO₄; 0<x≤1), ferrous sulfates (Fe₂(SO₄)₃), vanadium oxides (e.g., V₂O₅), LiNiₓCo_{y}M_{z}O₂ (x+y+z=1, x≥0.8; M consists of Mn and Al), and lithium nickel cobalt manganese composite oxides (LiₓNi_{1-y-z}Co_{y}Mn_{z}O₂; 0<x≤1, 0<y<1, 0<z<1, y+z<1).

Examples of compounds more preferred as the positive electrode active material among the above compounds include: lithium manganese composite oxides having a spinel structure (e.g., LiₓMn₂O₄; 0<x≤1), lithium manganese nickel composite oxides having a spinel structure (LiₓMn_{2-y}Ni_{y}O₄; 0<x≤1, 0<y<2), lithium nickel cobalt manganese composite oxides (LiₓNi_{1-y-z}Co_{y}Mn_{z}O₂; 0<x≤1, 0<y<1, 0<z<1, y+z<1), and lithium phosphorus oxides having an olivine structure (e.g., LiₓFePO₄; 0<x≤1, LiₓFe_{1-y}Mn_{y}PO₄; 0<x≤1, 0<y≤1, and LiₓCoPO₄; 0<x≤1). Using these compounds as the positive electrode active material can enhance the battery voltage. Lithium nickel cobalt manganese composite oxides represented by LiₓNi_{1-y-z}Co_{y}Mn_{z}O₂ wherein y and z are 0<y+z≤0.2 can realize a high energy density.

When the active material contains sulfur atoms in its composition, sulfur atoms derived from the active material may be contained in the extraction liquid in ICP emission spectrometry described later. That is, the mass of sulfur atoms per unit volume of the electrode mixture layer identified in the ICP emission spectrometry can include the mass of sulfur atoms derived from the active material. Also in this case, the mass of sulfur atoms per unit volume of the positive electrode mixture layer is 430 g/m³ or less.

The positive electrode active material may in the form of particles. The primary particle size of the positive electrode active material is preferably 100 nm to 1 μm. A positive electrode active material having a primary particle size of 100 nm or more is easy to handle during industrial production. A positive electrode active material having a primary particle size of 1 μm or less enables diffusion of lithium ions in a solid to proceed smoothly.

The specific surface area of the positive electrode active material is preferably 0.1 m²/g to 10 m²/g. A positive electrode active material having a specific surface area of 0.1 m²/g or more can secure sufficient sites for inserting and extracting Li ions. A positive electrode active material having a specific surface area of 10 m²/g or less is easy to handle during industrial production, and can secure good charge-and-discharge cycle performance.

The binder is added to fill gaps among the dispersed positive electrode active material and to bind the positive electrode active material with the positive current collector. Examples of the binder include polytetrafluoro ethylene (PTFE), polyvinylidene fluoride (PVdF), fluororubber, polyacrylic acid compounds, imide compounds, carboxymethyl cellulose (CMC), and salts of CMC. One of these may be used as the binder, or two or more of these may be used in combination as the binder.

The conductive agent is added to enhance current collecting performance and to suppress a contact resistance between the positive electrode active material and the positive electrode current collector. Examples of the conductive agent include carbonaceous materials such as vapor grown carbon fiber (VGCF), carbon blacks such as acetylene black, and graphite. One of these may be used as the conductive agent, or two or more of these may be used in combination as the conductive agent. The conductive agent may be omitted.

In the positive electrode mixture layer, the positive electrode active material and the binder are preferably blended at a ratio of 80% by mass to 98% by mass and 2% by mass to 20% by mass, respectively.

Setting the amount of the binder to 2% by mass or more can provide sufficient electrode strength. The binder may serve as an insulator. Thus, setting the amount of the binder to 20% by mass or less reduces the amount of an insulator included in the electrode and thus can decrease the internal resistance.

When a conductive agent is to be added, the positive electrode active material, the binder, and the conductive agent are preferably blended at a ratio of 77% by mass to 95% by mass, 2% by mass to 20% by mass, and 3% by mass to 15% by mass, respectively.

Setting the amount of the conductive agent to 3% by mass or more can produce the above-described effects. Setting the amount of the conductive agent to 15% by mass or less can decrease the proportion of the conductive agent that contacts the electrolyte. If said proportion is low, decomposition of the electrolyte can be reduced during storage under high temperature.

The positive electrode current collector is preferably an aluminum foil, or an aluminum alloy foil containing one or more elements selected from Mg, Ti, Zn, Ni, Cr, Mn, Fe, Cu, and Si.

The thickness of the aluminum foil or aluminum alloy foil is preferably 5 μm to 20 μm, and more preferably 15 μm or less. The purity of the aluminum foil is preferably 99% by mass or more. The amount of a transition metal such as iron, copper, nickel, or chromium contained in the aluminum foil or aluminum alloy foil is preferably 1% by mass or less.

The positive electrode current collector may also include a portion that does not have the positive electrode mixture layer formed on its surface. This portion can serve as a positive electrode current-collecting tab.

### 2) Negative Electrode

The negative electrode may include a current collector and a negative electrode mixture layer. The negative electrode mixture layer may be formed on one side or both sides of the current collector. The negative electrode mixture layer may contain a negative electrode active material, and optionally a conductive agent and a binder. The negative electrode mixture layer preferably contains sulfur atoms. The negative electrode mixture layer may include the negative electrode sulfur-containing phase described above. The sulfur atoms may be contained in the negative electrode sulfur-containing phase. The negative electrode sulfur-containing phase may be present on at least a part of the surface of the negative electrode, or may cover at least a part of the surface of the negative electrode active material particles. The negative electrode sulfur-containing phase may have a film shape or a layered shape.

The negative electrode active material is not particularly limited as long as it allows lithium or lithium ions to be inserted thereinto and extracted therefrom. One, or two or more kinds of negative electrode active materials may be used. Examples of the negative electrode active material include titanium-containing oxides, niobium-containing oxides, and carbon materials.

Examples of the titanium-containing oxides include lithium titanium-containing oxides and titanium oxides. Examples of the niobium-containing oxides include niobium titanium oxides, niobium tungsten-containing oxides, and niobium titanium molybdenum-containing oxides.

Examples of the titanium-containing oxides include lithium titanates having a ramsdellite structure (e.g., Li_{2+y}Ti₃O₇, 0≤y≤3), lithium titanates having a spinel structure (e.g., Li₄₊ₓTi₅O₁₂, 0≤x≤3), monoclinic titanium dioxide (TiO₂), anatase-type titanium dioxide, rutile-type titanium dioxide, hollandite-type titanium composite oxides, and orthorhombic titanium composite oxides. The lithium-ion insertion-extraction electric potential of the titanium-containing oxides is 0.4 V (vs. Li/Li⁺) or more.

Examples of the orthorhombic titanium-containing composite oxides include compounds represented by Li₂₊ₐM^{I}_{2-b}Ti_{6-c}M^{II}dO_{14+σ}. Here, M^{I} is at least one selected from the group consisting of Sr, Ba, Ca, Mg, Na, Cs, Rb, and K. M^{II} is at least one selected from the group consisting of Zr, Sn, V, Nb, Ta, Mo, W, Y, Fe, Co, Cr, Mn, Ni, and Al. The respective subscripts in the composition formula are specified as follows: 0≤a≤6, 0≤b<2, 0≤c<6, 0≤d<6, −0.5≤σ≤0.5. A specific example of the orthorhombic titanium-containing composite oxides is Li₂₊ₐNa₂Ti₆O₁₄ (0≤a≤6).

Examples of the niobium-containing oxides include niobium oxides, niobium titanium oxides, niobium tungsten-containing oxides, and niobium titanium molybdenum-containing oxides.

Examples of the niobium titanium oxides include monoclinic niobium titanium oxides. Examples of the monoclinic niobium titanium oxides include compounds represented by LiₓTi_{1-y}M1_{y}Nb_{2-z}M2_{z}O_{7+δ}. Here, M1 is at least one selected from the group consisting of Zr, Si, and Sn, and M2 is at least one selected from the group consisting of V, Ta, and Bi. M2 is at least one selected from the group consisting of V, Ta, and Bi. The respective subscripts in the composition formula are specified as follows: 0≤x≤5, 0≤y<1, 0≤z<2, and −0.3≤δ≤0.3. A specific example of the monoclinic niobium titanium oxides is LiₓNb₂TiO₇ (0≤x≤5).

Other examples of the monoclinic niobium titanium oxides include compounds represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formula are specified as follows: 0≤x≤5, 0≤y<1, 0≤z<2, and −0.3≤δ≤0.3.

Examples of the carbon material include graphite and hard carbon. When a carbon material is used in the negative electrode, a copper foil is used as the negative electrode current collector.

Among the negative electrode active materials, the monoclinic niobium titanium oxides have a lithium-ion insertion-extraction electric potential of around 1.0 V (vs. Li/Li⁺), and can thus cause a decomposition reaction of propanesultone to occur moderately. The lithium-ion insertion-extraction electric potential of the lithium titanate is around 1.4 V (vs. Li/Li⁺), and the lithium-ion insertion-extraction electric potential of the carbon material is around 0 V (vs. Li/Li⁺).

The negative electrode active material may have a particle shape.

The conductive agent is added to enhance current collecting performance and to suppress a contact resistance between the active material and the current collector. Examples of the conductive agent include carbonaceous materials such as vapor grown carbon fiber (VGCF), carbon nanotube, carbon black such as acetylene black, and graphite. One of these may be used as the conductive agent, or two or more of these may be used in combination as the conductive agent. Alternatively, instead of using a conductive agent, a carbon coating or an electron-conductive inorganic material coating may be applied to the surface of the active material particles.

The binder is added to fill gaps among the dispersed active material and to bind the active material with the current collector. Examples of the binder include polytetrafluoro ethylene (PTFE), polyvinylidene fluoride (PVdF), fluororubber, styrene-butadiene rubber, a polyacrylic acid compounds, imide compounds, carboxymethyl cellulose (CMC), and salts of CMC. One of these may be used as the binder, or two or more of these may be used in combination as the binder.

As one example of the blending ratio of the negative electrode active material, conductive agent and binder in the negative electrode mixture layer, the negative electrode active material, the conductive agent, and the binder are preferably blended at a ratio of 68% by mass to 96% by mass, 2% by mass to 30% by mass, and 2% by mass to 30% by mass, respectively. Setting the amount of the conductive agent to 2% by mass or more can improve the current-collecting performance of the negative electrode mixture layer. Also, setting the amount of the binder to 2% by mass or more provides sufficient binding between the negative electrode mixture layer and the current collector, and excellent cycle performance can be expected. On the other hand, the amount of each of the conductive agent and the binder is preferably 30% by mass or less in view of increasing the capacity.

As the current collector, a material is used which is electrochemically stable at the electric potential at which lithium (Li) is inserted into and extracted from the negative electrode active material. An example of the current collector for the case where a material having a lithium-ion insertion-extraction electric potential of 0.4 V (vs. Li/Li⁺) or higher is used as the negative electrode active material is copper, nickel, stainless steel, aluminum, or an aluminum alloy containing at least one element selected from Mg, Ti, Zn, Mn, Fe, Cu, and Si. The thickness of the current collector is preferably 5 μm to 20 μm. A current collector having such a thickness can maintain a balance between the strength and the weight reduction of the electrode.

The current collector may also include a portion that does not have the negative electrode mixture layer formed on its surface. This portion can serve as a negative electrode current collecting tab.

### 3) Nonaqueous Electrolyte

For example, a liquid nonaqueous electrolyte or a gel nonaqueous electrolyte may be used as a nonaqueous electrolyte. The liquid nonaqueous electrolyte contains an electrolyte salt, an organic solvent capable of dissolving the electrolyte salt, propanesultone (1,3-propanesultone), and lithium difluorophosphate. The concentration of the electrolyte salt is preferably 0.5 mol/L to 2.5 mol/L.

Each of propanesultone and lithium difluorophosphate may or may not serve as an electrolyte salt or an organic solvent. Propanesultone and lithium difluorophosphate may also serve as an electrolyte salt or an organic solvent.

The composition of the nonaqueous electrolyte contained in the secondary battery of the embodiment, particularly the concentration of propanesultone and lithium difluorophosphate may be changed from the composition (initial composition) of the nonaqueous electrolyte immediately after preparation. This is because, for example, propanesultone and lithium difluorophosphate can be consumed during initial charging-discharging, aging, and other processes after assembling the secondary battery subjected to the first sealing using the nonaqueous electrolyte immediately after preparation.

That is, the nonaqueous electrolyte is preferably prepared so that the concentration of propanesultone in the nonaqueous electrolyte is 0.5% by mass or more and the concentration of lithium difluorophosphate is 0.2% by mass or more in the secondary battery of the embodiment after initial charging-discharging and aging.

Specifically, it is preferable to prepare the nonaqueous electrolyte so that the concentration (initial concentration) of propanesultone in the nonaqueous electrolyte immediately after preparation falls within the range of 0.7% by mass to 5% by mass. The initial concentration of propanesultone may be 1.0% by mass or more.

The higher the initial concentration of propanesultone, the more propanesultone remains in the nonaqueous electrolyte even after the initial charging-discharging.

The lower the initial concentration of propanesultone, the less decomposition products generated by the reaction of propanesultone with the electrode active material, so that the resistance increase of the electrodes can be suppressed.

Since the secondary battery according to the embodiment contains lithium difluorophosphate in the nonaqueous electrolyte in addition to propanesultone, even if the initial concentration of propanesultone is lowered, propanesultone tends to remain in the nonaqueous electrolyte even after initial charging-discharging. Therefore, both suppression of the increase in resistance of the electrode and suppression of decomposition of the nonaqueous electrolyte can be achieved.

When the nonaqueous electrolyte is prepared such that the concentration (initial concentration) of lithium difluorophosphate in the nonaqueous electrolyte immediately after the preparation is high, the effect of suppressing decomposition of propanesultone is easily obtained. The initial concentration of lithium difluorophosphate is preferably 0.3% by mass or more, and more preferably 0.5% by mass or more. When the initial concentration of lithium difluorophosphate is low, precipitation of lithium difluorophosphate in the nonaqueous electrolyte can be suppressed. The initial concentration of lithium difluorophosphate is preferably 5% by mass or less, and more preferably 3% by mass or less.

The nonaqueous electrolyte is preferably prepared such that the ratio of the initial concentration of propanesultone:the initial concentration of lithium difluorophosphate (PS:DFP initial concentration ratio) is 1:9 to 10:1. That is, it is preferable to adjust the initial concentration of lithium difluorophosphate to 0.1 times to 9 times greater than the initial concentration of propanesultone. Within the above range, the effect of suppressing decomposition of propanesultone by lithium difluorophosphate is easily obtained, and the initial concentration of propanesultone can be lowered. Therefore, the resistance increase can be suppressed.

Examples of the electrolyte salt include lithium salts such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), lithium bis(trifluoro methanesulfonyl)imide (LiTFSI, LiN(CF₃SO₂)₂), and lithium bis(fluorosulfonyl)imide (LiFSI, LiN(FSO₂)₂), and mixtures thereof. The electrolyte salt is preferably less likely to be oxidized even at high potentials, and LiPF₆ is most preferred.

Examples of the organic solvent include: cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2MeTHF), and dioxolane (DOX); linear ethers such as dimethoxy ethane (DME) and diethoxy ethane (DEE); γ-butyrolactone (GBL); acetonitrile (AN); ethyl propionate (EP); and sulfolane (SL). These organic solvents may be used alone or in the form of a mixed solvent.

The gel nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Other than the liquid nonaqueous electrolyte and the gel nonaqueous electrolyte, a room temperature molten salt (ionic melt) including lithium ions, a polymer solid electrolyte, an inorganic solid electrolyte, and the like may also be used as the nonaqueous electrolyte.

### 4) Separator

The separator is made of, for example, a synthetic resin nonwoven fabric or a porous film including polyethylene (PE), polypropylene (PP), cellulose, or polyvinylidene fluoride (PVdF). In view of safety, a porous film made of polyethylene or polypropylene is preferably used. This is because such a porous film melts at a fixed temperature and thus is able to shut off current.

An electrolyte layer including an inorganic solid electrolyte may be used as the separator. Examples of the lithium-ion conductive inorganic solid electrolyte include a lithium-ion conductive oxide-based solid electrolyte or a lithium-ion conductive sulfide-based solid electrolyte. Examples of the lithium-ion conductive oxide-based solid electrolyte include a lithium phosphoric acid solid electrolyte having a NASICON-type structure, amorphous LIPON (Li_{2.9}PO_{3.3}N_{0.46}), and LLZ (Li₇La₃Zr₂O₁₂) having a garnet-type structure.

### 5) Container Member

For example, a container made of laminated film or a metallic container may be used as the container member.

The thickness of the laminated film is, for example, 0.5 mm or less, and preferably 0.2 mm or less.

As the laminated film, a multilayer film including multiple resin layers and a metal layer interposed between the resin layers is used. The resin layer includes, for example, a polymeric material such as polypropylene (PP), polyethylene (PE), nylon, or polyethylene terephthalate (PET). The metal layer is preferably made of an aluminum foil or an aluminum alloy foil for reduction in weight. The laminated film may be formed into the shape of the container member by heat-sealing.

The wall thickness of the metallic container is, for example, 1 mm or less, more preferably 0.5 mm or less, and still more preferably 0.2 mm or less.

The metallic container is made, for example, of aluminum, an aluminum alloy or the like. The aluminum alloy preferably contains an element(s) such as magnesium, zinc, silicon, and the like. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), prismatic, cylindrical, coin-shaped, button-shaped, or the like. The container member can be suitably selected depending on the size of the battery or the use of the battery.

### <Measurement Method>

A method for measuring the mass (g/m³) of sulfur atoms per unit volume of the positive electrode mixture layer or the negative electrode mixture layer, the concentration (% by mass) of propanesultone in the nonaqueous electrolyte, and the concentration (% by mass) of lithium difluorophosphate will be described below.

### (Preparation of Measurement Sample)

The container member of the secondary battery having a state of charge (SOC) of 50% is opened to take out an electrode group. The jig (e.g., tape) that bundles the electrode group is detached, and if the outermost layer is a separator, the separator is flipped to take out the electrode (e.g., negative electrode) at the first layer. Then, another separator is flipped to take out the counter electrode (e.g., positive electrode) at the first layer. Flipping of the separator to take out the electrode is repeated to take out all the positive electrodes and the negative electrodes constituting the electrode group. The removed electrodes and separators are centrifuged to extract the nonaqueous electrolyte and to separate the electrodes from the separators.

### (ICP Emission Spectrometry)

The mass (g/m³) of sulfur atoms per unit volume of the positive electrode mixture layer or the negative electrode mixture layer is measured according to inductively coupled plasma (ICP) emission spectrometry. Each electrode separated by the above centrifuge is washed with methyl ethyl carbonate (MEC) and vacuum-dried. Each electrode is punched out into a fixed area (2×2 cm²), followed by the addition of a fixed amount of pure water (10 cc) thereto and performance of ultrasonic irradiation for 30 minutes or longer. By analyzing the liquid extracted therefrom according to ICP and measuring the amount of sulfur atoms in the extraction liquid, the mass of the sulfur atoms per unit volume of each electrode mixture layer is obtained.

### (GC-MS)

The nonaqueous electrolyte extracted by the above-described method is diluted with acetonitrile to a volume of 20 times and used as a measurement sample. The concentration (% by mass) of propanesultone in the nonaqueous electrolyte can be identified by performing gas chromatography mass spectrometry (GC-MS) measurement on the measurement sample under the conditions shown in the following Table 1.

TABLE 1

| Apparatus | Item | Conditions |
|---|---|---|
| GC | Injection volume | 1 uL |
| | Column | Ultra Alloy CW 40 m 0.25 mm 0.25 μm |
| | Temperature | 40° C. (held for 2 minutes), temperature |
| | | rise at 10° C./minute, 240° C. (10 min) |
| | Split Ratio | 1:50 |
| | He flow rate | 1.0 mL/min |
| MS | Mass range | 10-600 m/z |

### (Capillary Electrophoresis)

The concentration (% by mass) of lithium difluorophosphate in the nonaqueous electrolyte can be identified by diluting the nonaqueous electrolyte extracted by the above method to 20 times its volume with acetonitrile and subjecting it as a measurement sample to capillary electrophoresis (CE) under the following measurement conditions.
Capillary inner diameter: 50 μm, length: 72 cm
Applied voltage: −30 kV
Temperature: 10° C.
Electrophoretic solution: Inorganic anion analysis buffer manufactured by Agilent Technologies
Detection wavelength: Signal=350 (±80) nm, Ref=245 (±10) nm
Measurement time: 20 min

According to the first embodiment described above, a secondary battery including a positive electrode, a negative electrode, and a nonaqueous electrolyte is provided. The positive electrode includes a positive electrode mixture layer containing a positive electrode active material and sulfur atoms. A mass of sulfur atoms per unit volume of the positive electrode mixture layer is 430 g/m³ or less. The nonaqueous electrolyte contains propanesultone and lithium difluorophosphate. A concentration of the propanesultone in the nonaqueous electrolyte is 0.5% by mass or more. A concentration of the lithium difluorophosphate in the nonaqueous electrolyte is 0.2% by mass or more. Therefore, a secondary battery having high output performance and high high-temperature durability can be realized.

### Second Embodiment

A battery pack according to a second embodiment may include the secondary battery (single battery) according to the embodiment in a single number or plural numbers. A plurality of secondary batteries may be electrically connected in series, in parallel, or in a combination of in-series connection and in-parallel connection, to constitute a battery module. The battery pack according to the embodiment may include a plurality of battery modules.

The battery pack according to the embodiment may further include a protective circuit. The protective circuit functions to control charge and discharge of the secondary battery. Alternatively, a circuit included in devices (such as electronic devices, automobiles and the like) that use a battery pack as a power source may be used as the protective circuit of the battery pack.

The battery pack according to the embodiment may further include an external power distribution terminal. The external power distribution terminal is configured to output current from the secondary battery to the outside and to input current into the secondary battery. In other words, when the battery pack is used as a power source, current is supplied to the outside via the external power distribution terminal. When charging the battery pack, charge current (including regenerative energy of a motive force of vehicles such as automobiles) is supplied to the battery pack through the external power distribution terminal.

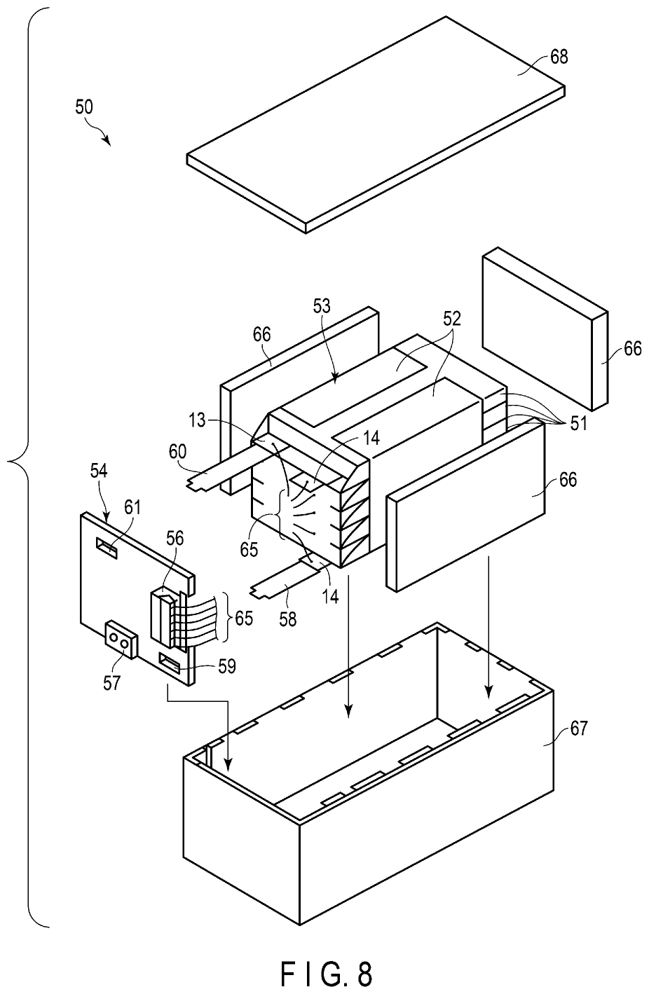

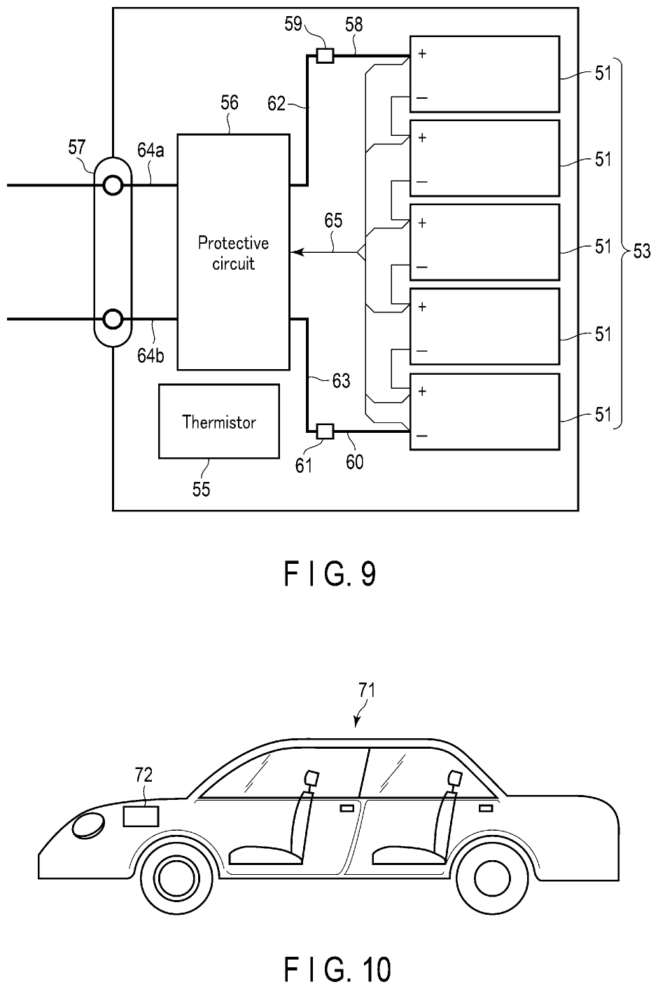

FIGS. 8 and 9 show an example of a battery pack 50. The battery pack 50 includes a plurality of flat batteries having the structure shown in FIG. 8. FIG. 8 is an exploded perspective view of the battery pack 50. FIG. 9 is a block diagram showing an electric circuit of the battery pack 50 shown in FIG. 8.

A plurality of single batteries 51 are stacked such that the negative electrode terminal 13 and positive electrode terminal 14 extending outward are aligned in the same direction, and are fastened with an adhesive tape 52, to thereby constitute a battery module 53. These single batteries 51 are electrically connected to each other in series, as shown in FIG. 9.

A printed wiring board 54 is arranged facing the side surfaces of the single batteries 51 from which the negative electrode terminals 13 and the positive electrode terminals 14 extend. A thermistor 55, a protective circuit 56, and a power distribution terminal 57 for energizing an external device as the external power distribution terminal are mounted on the printed wiring board 54 as shown in FIG. 9. An insulating plate (not shown) is attached to the surface of the printed wiring board 54 facing the battery module 53 to avoid unnecessary connection with the wires of the battery module 53.

A positive electrode-side lead 58 is connected to the positive electrode terminal 14 positioned at the bottom layer of the battery module 53 and the distal end of the positive electrode-side lead 58 is inserted into a positive electrode-side connector 59 of the printed wiring board 54 so as to be electrically connected. A negative electrode-side lead 60 is connected to the negative electrode terminal 13 positioned at the top layer of the battery module 53 and the distal end of the negative electrode-side lead 60 is inserted into a negative electrode-side connector 61 of the printed wiring board 54 so as to be electrically connected. The connectors 59 and 61 are connected to the protective circuit 56 through wires 62 and 63 formed on the printed wiring board 54.

The thermistor 55 detects the temperature of the single batteries 51, so that the detection signals are transmitted to the protective circuit 56. The protective circuit 56 can shut down a plus-side wire 64a and a minus-side wire 64b between the protective circuit 56 and the power distribution terminal 57 for energizing an external device as the external power distribution terminal under a predetermined condition. The predetermined condition is, for example, a case where the temperature detected by the thermistor 55 reaches a predetermined temperature or higher. The predetermined condition is also a case where overcharge, overdischarge, over-current, or the like of the single batteries 51 is detected. The detection of the overcharge or the like is performed for the individual single batteries 51 or the single batteries 51 as a whole. In the case of detecting the individual single batteries 51, a battery voltage may be detected, or a positive electrode potential or a negative electrode potential may be detected. In the latter case, a lithium electrode used as a reference electrode is inserted into each single battery 51. In the instance shown in FIGS. 8 and 9, a wire 65 for voltage detection is connected to each of the single batteries 51, and detection signals are transmitted to the protective circuit 56 through the wire 65.

Protective sheets 66 made of rubber or resin are arranged on three side surfaces of the battery module 53, excluding the side surface from which the positive electrode terminal 14 and the negative electrode terminal 13 protrude.

The battery module 53 is housed in the housing container 67 together with each protective sheet 66 and the printed wiring board 54. That is, the protective sheets 66 are arranged on both of the inner side surfaces in the long-side direction and an inner side surface in the short-side direction of the housing container 67, and the printed wiring board 54 is disposed on the opposite inner side surface in the short-side direction. The battery module 53 is positioned in a space surrounded by the protective sheets 66 and the printed wiring board 54. A lid 68 is attached to an upper surface of the housing container 67.

In order to fix the battery module 53, a heat-shrinkable tape may be used in place of an adhesive tape 52. In this case, the battery module is bound by placing the protective sheets on both sides of the battery module, winding the heat-shrinkable tape around the battery module, and then thermally shrinking the heat-shrinkable tape.

FIGS. 8 and 9 show the configuration in which the single batteries 51 are connected in series; however, the single batteries 51 may be connected in parallel to increase the battery capacity. Alternatively, the single batteries 51 may be connected in a combination of in-series connection and in-parallel connection. The assembled battery packs can also be connected in series or in parallel.

The battery pack shown in FIGS. 8 and 9 includes a single battery module; however, the battery pack according to the embodiment may include a plurality of battery modules. The plurality of battery modules are electrically connected in series, in parallel, or in a combination of in-series connection and in-parallel connection.

The form of the battery pack can be appropriately changed depending on the application. The battery pack according to the embodiment is suitably used in applications where excellent cycle performance is demanded when a large current is extracted. Specifically, the battery pack is used as a power source of a digital camera, a battery of a vehicle such as a two- or four-wheeled hybrid electric automobile, a two- or four-wheeled electric automobile, an electric bicycle, or a railway vehicle (such as an electric train), or a stationary battery. In particular, the battery pack is suitably used as an in-vehicle battery installed in vehicles.

The battery pack of the second embodiment described above includes the secondary battery of the embodiment. Therefore, excellent output performance and excellent high-temperature durability can be realized.

### Third Embodiment

A vehicle of a third embodiment includes one, or two or more of the secondary battery of the embodiment, or includes the battery pack of the embodiment.

In a vehicle, such as an automobile, including the battery pack according to the third embodiment, it is preferable that the battery pack, for example, recover regenerative energy of a motive force of the vehicle. The vehicle may include a mechanism configured to convert kinetic energy of the vehicle into regenerative energy.

FIG. 10 shows an example of an automobile including an example battery pack according to the embodiment.

An automobile 71 shown in FIG. 10 includes an example battery pack 72 according to the embodiment in the engine compartment in a front part of the automobile. The place where the battery pack is installed in the automobile is not limited to the engine compartment. For example, the battery pack may be installed in a rear part of the automobile or under a seat.

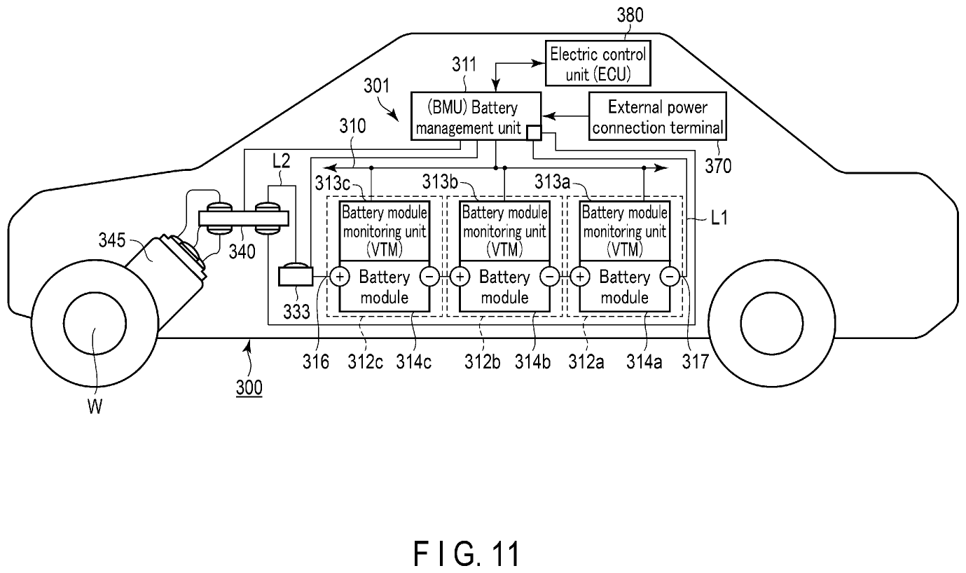

FIG. 11 is a diagram schematically showing an example configuration of the vehicle according to the embodiment. A vehicle 300 shown in FIG. 11 is an electric automobile.

The vehicle 300 shown in FIG. 11 includes a vehicle power source 301, a vehicle electric control unit (ECU) 380, which is a master controller of the vehicle power source 301, an external terminal 370, an inverter 340, and a drive motor 345.

The vehicle 300 includes the vehicle power source 301 in the engine compartment, in a rear part of the automobile or under a seat, for example. FIG. 11, however, schematically shows an installing position of the secondary battery in the vehicle 300.

The vehicle power source 301 includes a plurality of (e.g., three) battery packs 312a, 312b, and 312c, a battery management unit (BMU) 311, and a communication bus 310.

The three battery packs 312a, 312b, and 312c are electrically connected in series. The battery pack 312a includes a battery module 314a and a voltage temperature monitor (VTM) 313a. The battery pack 312b includes a battery module 314b and a voltage temperature monitor 313b. The battery pack 312c includes a battery module 314c and a voltage temperature monitor 313c. The battery packs 312a, 312b, and 312c are removable independently of each other, and each can be replaced with a different battery pack.

Each of the battery modules 314a to 314c includes a plurality of secondary batteries electrically connected in series. Each of the secondary batteries is the secondary battery according to the embodiment. The battery modules 314a to 314c each perform charge and discharge via a positive electrode terminal 316 and a negative electrode terminal 317.

To collect information related to maintenance of the vehicle power source 301, the battery management unit 311 communicates with the voltage temperature monitors 313a to 313c and collects information on the voltage, temperature, and the like of the secondary batteries of the battery modules 314a to 314c included in the vehicle power source 301.

The battery management unit 311 and the voltage temperature monitors 313a to 313c are connected via the communication bus 310. The communication bus 310 is configured to share a set of communication wires with a plurality of nodes (a battery management unit and at least one voltage temperature monitor). The communication bus 310 is, for example, a communication bus configured based on the control area network (CAN) standard.

The voltage temperature monitors 313a to 313c measure a voltage and a temperature of individual secondary batteries constituting the battery modules 314a to 314c based on commands received from the battery management unit 311 through communication. The temperature may be measured only at several points per battery module, and it is not necessary to measure the temperatures of all the secondary batteries.

The vehicle power source 301 may also include an electromagnetic contactor (such as a switch unit 333 shown in FIG. 11) configured to switch on and off a connection between the positive electrode terminal and the negative electrode terminal. The switch unit 333 includes a pre-charge switch (not shown) which turns on when the battery modules 314a to 314c are charged, and a main switch (not shown) which turns on when the output from the battery is supplied to a load. The pre-charge switch and the main switch include a relay circuit (not shown), which is turned on and off based on a signal supplied to a coil disposed near the switch elements.

The inverter 340 converts an input direct current voltage into a high voltage of a three-phase alternate current (AC) for driving a motor. The output voltage from the inverter 340 is controlled based on a control signal from the battery management unit 311 or the vehicle ECU 380 configured to control the entire operation of the vehicle. Three-phase output terminals of the inverter 340 are respectively connected to three-phase input terminals of the drive motor 345.

The drive motor 345 is rotated by electric power supplied from the inverter 340, and transmits the rotation to axles and drive wheels W via, for example, a differential gear unit.

The vehicle 300 also includes a regenerative brake mechanism (not shown) configured to rotate the drive motor 345 when the vehicle 300 is braked, and convert kinetic energy into regenerative energy as electric energy. The regenerative energy recovered in the regenerative brake mechanism is input to the inverter 340 and converted into a direct current. The direct current is input to the vehicle power source 301.

One of the terminals of a connection line L1 is connected to the negative electrode terminal 317 of the vehicle power source 301 via a current detector (not shown) included in the battery management unit 311. The other of the terminals of the connection line L1 is connected to a negative electrode input terminal of the inverter 340.

One of the terminals of a connection line L2 is connected to the positive electrode terminal 316 of the vehicle power source 301 via the switch unit 333. The other of the terminals of the connection line L2 is connected to a positive electrode input terminal of the inverter 340.

The external terminal 370 is connected to the battery management unit 311. The external terminal 370 can be connected to, for example, an external power source.

The vehicle ECU 380 controls the battery management unit 311 cooperatively with other apparatuses in response to operation input from a driver, etc., and thereby manages the entire vehicle. Data related to maintenance of the vehicle power source 301, such as a remaining capacity of the vehicle power source 301, is transferred between the battery management unit 311 and the vehicle ECU 380 through a communication line.

Since the vehicle of the embodiment includes battery packs which include the secondary battery according to the embodiment, and the battery packs (e.g., battery packs 312a, 312b, and 312c) have excellent output performance and high-temperature durability, a vehicle excellent in charge-and-discharge performance and high in reliability can be obtained. In addition, the battery packs are inexpensive and highly safe, and thus can suppress the costs of the vehicle and enhance the safety of the vehicle.

### EXAMPLES

A secondary battery was produced according to the procedure described below.

### Example 1

### <Production of Positive Electrode>

A lithium nickel cobalt manganese composite oxide (LiNi_{0.8}Co_{0.1}Mn_{0.1}O₂) powder was provided as a positive electrode active material. Acetylene black was provided as a conductive agent. Polyvinylidene fluoride (PVdF) was provided as a binder. Then, the positive electrode active material, the conductive agent, and the binder were mixed in N-methylpyrrolidone (NMP) as a solvent at a ratio of 82% by mass:9% by mass:9% by mass, whereby a positive electrode slurry was prepared. The positive electrode slurry was applied onto both surfaces of a current collector made of an aluminum foil having a thickness of 15 μm. Then, the coating was dried in a thermostatic chamber at 120° C. to form a positive electrode active material-containing layer, followed by pressing of the positive electrode active material-containing layer. Thereby, the positive electrode was obtained.

### <Production of Negative Electrode>

A niobium titanium oxide (Nb₂TiO₇) powder was provided as a negative electrode active material. The average secondary particle size of the niobium titanium oxide was 7.5 μm. The specific surface area of the niobium titanium oxide was 4.0 m²/g. In addition, acetylene black was provided as a conductive agent, and polyvinylidene fluoride (PVdF) was provided as a binder. Then, the negative electrode active material, the conductive agent, and the binder were mixed in N-methylpyrrolidone (NMP) as a solvent at a ratio of 82% by mass:9% by mass:9% by mass, whereby a negative electrode slurry was prepared. The negative electrode slurry was applied onto both surfaces of a current collector made of an aluminum foil having a thickness of 15 μm. Then, the coating was dried in a thermostatic chamber at 120° C. to form a negative electrode active material-containing layer, followed by pressing of the negative electrode active material-containing layer. Thereby, the negative electrode was obtained.

### <Production of Electrode Group>

The positive and negative electrodes were vacuum-dried at 120° C. for 24 hours. Two non-woven fabrics made of polyethylene and having a thickness of 25 μm were provided as a separator. Next, the positive electrode, separator, negative electrode, and separator were stacked in this order to obtain a stack. Then, the stack was spirally wound. This was subjected to hot pressing at 80° C., whereby a flat electrode group was produced. A positive electrode terminal was electrically connected to the positive electrode of the electrode group. A negative electrode terminal was electrically connected to the negative electrode of the electrode group.

### <Housing of Electrode Group>

A container made of a laminated film having a three-layer structure of nylon layer/aluminum layer/polyethylene layer and having a thickness of 0.1 mm was prepared. The electrode group produced as described above was housed in the container. Then, the inside of the container was dried in vacuum at 80° C. for 16 hours with the periphery of the container partially opened.

### <Preparation of Liquid Nonaqueous Electrolyte>

As a solvent, a mixed solvent of propylene carbonate (PC) and diethyl carbonate (December) (volume ratio being 1:2) was prepared. LiPF₆ as an electrolyte salt was dissolved in a solvent at a concentration of 1 mol/L. To this, 1,3 propanesultone (PS) was added so that the initial concentration in the nonaqueous electrolyte was 1.0% by mass, and dissolved. Further, lithium difluorophosphate (DFP) was added and dissolved to an initial concentration of 1.0% by mass. That is, a nonaqueous electrolyte was prepared such that the initial concentration of PS:the initial concentration of DFP (PS:DFP initial concentration ratio) was 1:1. A liquid nonaqueous electrolyte (nonaqueous electrolytic solution) was thus obtained. The preparation of the liquid nonaqueous electrolyte was performed in an argon box.

### <Production of Battery>

The nonaqueous electrolytic solution was poured into the container that houses the electrode group. Then, the opened portion of the periphery of the container was heat-sealed to seal up the container. A battery having external dimensions of 11 cm×8 cm×0.3 cm excluding the positive and negative electrode terminals (also referred to as “positive and negative electrode tabs”) and having internal dimensions (dimensions of the sealed portion) of 9 cm×7 cm×0.25 cm was thus obtained. The battery thus obtained is referred to as a “first-sealed battery”.

### <Initial Charge>

Initial charging-discharging was performed by performing the following initial charge and initial discharge. The first-sealed battery was subjected to initial charging in an environment of 25° C. through the following procedure. First, the first-sealed battery was charged at a constant current (CC) of 0.2 C until the voltage reached 3 V. The first-sealed battery was then charged at a constant voltage (CV) of 3 V. The constant-voltage charge was terminated when the total time of the constant-current charge and the constant-voltage charge reached 10 hours.

### <Initial Discharge>

Next, the first-sealed battery was discharged at a constant current (CC) of 0.2 C in an environment of 25° C. until the voltage reached 1.5 V.

### <Post-Treatment>

Next, the first-sealed battery after initial charging-discharging was charged at a constant current (CC) of 0.2 C in an environment of 25° C. until the voltage reached 3 V. The first-sealed battery was then charged at a constant voltage (CV) of 3 V until the current value became 1/20 C. Namely, the first-sealed battery was subjected to constant-current and constant-voltage (CCCV) charge. As a result, the SOC of the first-sealed battery was 100%. The first-sealed battery was subjected to aging. The aging was performed by holding at 35° C. for 35 hours in a thermostatic chamber. Thereafter, the first-sealed battery was put in in an argon box, and a single site of the sealing portion of the container member was cut to release the gas in the container member. The edge opened by cutting was sealed by heat sealing. A secondary battery of Example 1 was thus produced.

### Examples 2 to 6

A secondary battery was produced in the same manner as in Example 1 except that the positive electrode active material was changed as shown in Table 2.

### Examples 7, 9, and 10

A secondary battery was produced in the same manner as in Example 1 except that the negative electrode active material was changed as shown in Table 2.

### Example 8

The negative electrode active material was changed to C (graphite) as shown in Table 2. A graphite powder and polyvinylidene fluoride (PVdF) were mixed at a ratio of 90% by mass and 10% by mass, and the resultant mixture was kneaded in the presence of an organic solvent (N-methylpyrrolidone) to prepare a slurry. The obtained slurry was applied to a current collector made of a copper foil having a thickness of 15 μm, dried, and pressed, thereby obtaining a negative electrode. In addition, when the negative electrode containing graphite is used, the steps from the initial charging to the post-treatment were performed as described below to produce a secondary battery.

### <Initial Charge>

The first-sealed battery was subjected to initial charging in an environment of 25° C. through the following procedure. First, the first-sealed battery was charged at a constant current (CC) of 0.2 C until the voltage reached 4.15 V. The first-sealed battery was then charged at a constant voltage (CV) of 4.15 V. The constant-voltage charge was terminated when the total time of the constant-current charge and the constant-voltage charge reached 10 hours.

### <Initial Discharge>

Next, the first-sealed battery was discharged at a constant current (CC) of 0.2 C in an environment of 25° C. until the voltage reached 2 V.

### <Post-Treatment>

Next, the first-sealed battery after initial charging-discharging was charged at a constant current (CC) of 0.2 C in an environment of 25° C. until the voltage reached 4.15 V. The first-sealed battery was then charged at a constant voltage (CV) of 4.15 V until the current value became 1/20 C. Namely, the first-sealed battery was subjected to constant-current and constant-voltage (CCCV) charge. As a result, the SOC of the first-sealed battery was 100%. The first-sealed battery was subjected to aging. The aging was performed by holding at 35° C. for 35 hours in a thermostatic chamber. Thereafter, the first-sealed battery was put in in an argon box, and a single site of the sealing portion of the container member was cut to release the gas in the container member. The edge opened by cutting was sealed by heat sealing. A secondary battery of Example 8 was thus produced.

### Example 11

A secondary battery was produced in the same manner as in Example 1 except that a mixed solvent of propylene carbonate (PC) and methyl ethyl carbonate (MEC) (volume ratio being 1:2) was prepared as a solvent in the preparation of a liquid nonaqueous electrolyte.

### Example 12

A secondary battery was produced in the same manner as in Example 1 except that a mixed solvent of propylene carbonate (PC) and dimethyl carbonate (DMC) (volume ratio being 1:2) was prepared as a solvent in the preparation of a liquid nonaqueous electrolyte.

### Example 13

A secondary battery was produced in the same manner as in Example 1 except that a mixed solvent of propylene carbonate (PC) and ethyl propionate (EP) (volume ratio being 1:4) was prepared as a solvent in the preparation of a liquid nonaqueous electrolyte.

### Examples 14 to 18

In the preparation of the liquid nonaqueous electrolyte, the initial concentration of 1,3-propanesultone (PS) and the initial concentration of lithium difluorophosphate (DFP) were set to values shown in Tables 2 and 3. The initial concentration of PS initial concentration of DFP (PS:DFP initial concentration ratio) in the nonaqueous electrolyte in Examples is shown in Tables 2 and 3.

The aging temperature and time in the post-treatment were as shown in Tables 5 and 6.

A secondary battery was produced in the same manner as in Example 1 except for the above.

### Examples 19 to 21

A secondary battery was produced in the same manner as in Example 1 except that the aging temperature in the post-treatment was as described in Table 6.

### Examples 22 to 24

A secondary battery was produced in the same manner as in Example 1 except that the aging time in the post-treatment was as described in Table 6.

### Examples 25 to 27

In the preparation of the liquid nonaqueous electrolyte, the initial concentration of 1,3-propanesultone (PS) and the initial concentration of lithium difluorophosphate (DFP) were set to values shown in Table 3. The initial concentration of PS:initial concentration of DFP in the nonaqueous electrolyte in Examples is shown in Table 3.

The aging temperature and time in the post-treatment were as shown in Table 6.

A secondary battery was produced in the same manner as in Example 1 except for the above.

### Example 28

A secondary battery was produced in the same manner as in Example 1 except that the vacuum drying of the positive and negative electrodes was performed at 80° C. in the production of the electrode group.

### Example 29

A secondary battery was produced in the same manner as in Example 1 except that the vacuum drying of the positive and negative electrodes was not performed in the production of the electrode group. Since vacuum drying was not performed, the electrode drying temperature in Table 6 was indicated by “-”.

### Comparative Example 1

A secondary battery was produced in the same manner as in Example 1 except that 1,3-propanesultone (PS) was not added in the preparation of the liquid nonaqueous electrolyte.

### Comparative Example 2

A secondary battery was produced in the same manner as in Example 1 except that lithium difluorophosphate (DFP) was not added in the preparation of the liquid nonaqueous electrolyte.

### Comparative Examples 3 and 4

A secondary battery was produced in the same manner as in Example 1 except that the aging temperature and time in the post-treatment were as described in Table 7.

### Comparative Examples 5 and 6

In the preparation of the liquid nonaqueous electrolyte, the initial concentration of 1,3-propanesultone (PS) and the initial concentration of lithium difluorophosphate (DFP) were set to values shown in Table 4. The initial concentration ratio of PS:DFP in the nonaqueous electrolyte is shown in Table 4.

The aging temperature and time in the post-treatment were as shown in Table 7.

A secondary battery was produced in the same manner as in Example 1 except for the above.

### Comparative Example 7

In the preparation of the liquid nonaqueous electrolyte, the initial concentration of 1,3-propanesultone (PS) and the initial concentration of lithium difluorophosphate (DFP) were set to values shown in Table 4. The initial concentration of PS:initial concentration of DFP in the nonaqueous electrolyte is shown in Table 4.

A secondary battery was produced in the same manner as in Example 1 except for the above.

### <Measurement of Mass of Sulfur Atoms Per Unit Volume of Mixture Layer>

For the secondary batteries of Examples and Comparative Examples, the mass of sulfur atoms per unit volume of the positive electrode mixture layer (S content per positive electrode mixture layer) and the mass of sulfur atoms per unit volume of the positive electrode mixture layer (S content per negative electrode mixture layer) were measured by the ICP emission spectrometry described above. The measurement results are shown in Tables 8 to 10.

### <Measurement of Nonaqueous Electrolyte>

For the liquid nonaqueous electrolyte contained in each of the secondary batteries of Examples and Comparative Examples after the post-treatment, the concentration of propanesultone in the nonaqueous electrolyte (PS concentration in the nonaqueous electrolyte) and the concentration of lithium difluorophosphate (DFP concentration in the nonaqueous electrolyte) were measured by the method described above. The measurement results are shown in Tables 8 to 10.

### <Storage Test>

A storage test was performed on the secondary batteries of Examples and Comparative Examples as described below.

The secondary batteries were charged at a constant current (CC) of 0.2 C until the voltage reached 3 V. The batteries were then charged at a constant voltage (CV) of 3 V until the current value became 1/20 C. Namely, the battery was subjected to constant-current and constant-voltage (CCCV) charge to have an SOC of 100%. The charged battery was put in a thermostatic chamber at 55° C. The batteries were removed from the thermostatic chamber at 55° C. every 10 days and cooled to 25° C., and then subjected to CCCV charge at 3 V and put in the thermostatic chamber at 55° C. again. After repeating this, and cooling the battery stored in the thermostatic chamber for 90 days to 25° C. again, the volume of the battery was measured, and the difference between the measured volume and the volume prior to the test was determined to be the amount (ml) of gas generation. The amount of gas generation is an indicator of high-temperature durability.

### <Direct Current (DC) Resistance Measurement>

Prior to performing the storage test, DC resistance measurement was performed on the secondary batteries of Examples and Comparative Examples, as follows. The batteries were discharged at a constant current (CC) of 0.2 C until the voltage reached 1.5 V. Thereafter, the batteries were charged at a constant current (CC) of 0.2 C until the voltage reached 2.25 V. The batteries were then charged at a constant voltage (CV) of 2.25 V until the current value became 1/20 C to thereby have an SOC of 50%. The batteries adjusted to have an SOC of 50% were discharged at a constant current (CC) of 10 C for 10 ms, and a DC resistance (mΩ) was obtained from the difference between the voltage value and the current value at this time.

Furthermore, the DC resistance (mΩ) was determined by measuring the DC resistance of the secondary batteries after the storage test in the same manner as described above.

The DC resistance before the storage test is set to R1 and the DC resistance after the storage test is set to R2, the resistance increase value is obtained by dividing R2 by R1.

Tables 2 to 4 show the types of the positive and negative electrode active materials, the types of the solvent and the electrolyte salt used in the preparation of the liquid nonaqueous electrolyte, the initial concentrations of PS and DFP, and the initial concentration ratio of PS to DFP in Examples and Comparative Examples.

Tables 5 to 7 show the electrode drying temperature and time in the preparation of the electrode group, and the aging temperature and time in the post-treatment in Examples and Comparative Examples.

Tables 8 to 10 shows the S content per positive electrode mixture layer, the S content per negative electrode mixture layer, the PS concentration in the nonaqueous electrolyte, the DFP concentration in the nonaqueous electrolyte, the amount of gas generation (ml), and the resistance increase value in the secondary batteries after the post-treatment in Examples and Comparative Examples.

TABLE 2

| | Positive electrode | Negative electrode | Solvent for nonaqueous | PS initial | DFP initial | PS:DFP initial |
|---|---|---|---|---|---|---|
| | active material | active material | electrolyte, electrolyte salt | concentration | concentration | concentration ratio |
| Example 1 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 2 | LiNi_{0.5}Co_{0.2}Mn_{0.3}O₂ | Nb₂TiO₇ | PC:DEC = 1:2, LiPF₆ 1 mol/L | 1.0 | 1.0 | 1:1 |
| Example 3 | LiNi_{0.6}Co_{0.2}Mn_{0.2}O₂ | Nb₂TiO₇ | PC:DEC = 1:2, LiPF₆ 1 mol/L | 1.0 | 1.0 | 1:1 |
| Example 4 | LiNi_{0.5}Co_{0.2}Mn_{0.3}O₂ | Nb₂TiO₇ | PC:DEC = 1:2, LiPF₆ 1 mol/L | 1.0 | 1.0 | 1:1 |
| Example 5 | LiMn₂O₄ | Nb₂TiO₇ | PC:DEC = 1:2, LiPF₆ 1 mol/L | 1.0 | 1.0 | 1:1 |
| Example 6 | LiFePO₄ | Nb₂TiO₇ | PC:DEC = 1:2, LiPF₆ 1 mol/L | 1.0 | 1.0 | 1:1 |
| Example 7 | LiNi_{0.8}Co_{0.1}Mn_{0.1}O₂ | Li₄Ti₅O₁₂ | PC:DEC = 1:2, LiPF₆ 1 mol/L | 1.0 | 1.0 | 1:1 |
| Example 8 | LiNi_{0.8}Co_{0.1}Mn_{0.1}O₂ | C(graphite) | PC:DEC = 1:2, LiPF₆ 1 mol/L | 1.0 | 1.0 | 1:1 |
| Example 9 | LiNi_{0.8}Co_{0.1}Mn_{0.1}O₂ | Li₂Na_{1.8}Ti_{5.8}Nb_{0.2}O₁₄ | PC:DEC = 1:2, LiPF₆ 1 mol/L | 1.0 | 1.0 | 1:1 |
| Example 10 | LiNi_{0.8}Co_{0.1}Mn_{0.1}O₂ | TiO₂ | PC:DEC = 1:2, LiPF₆ 1 mol/L | 1.0 | 1.0 | 1:1 |
| Example 11 | LiNi_{0.8}Co_{0.1}Mn_{0.1}O₂ | Nb₂TiO₇ | PC:MEC = 1:2, LiPF₆ 1 mol/L | 1.0 | 1.0 | 1:1 |
| Example 12 | LiNi_{0.8}Co_{0.1}Mn_{0.1}O₂ | Nb₂TiO₇ | PC:DMC = 1:2, LiPF₆ 1 mol/L | 1.0 | 1.0 | 1:1 |
| Example 13 | LiNi_{0.8}Co_{0.1}Mn_{0.1}O₂ | Nb₂TiO₇ | PC:EP = 1:4, LiPF₆ 1 mol/L | 1.0 | 1.0 | 1:1 |
| Example 14 | LiNi_{0.8}Co_{0.1}Mn_{0.1}O₂ | Nb₂TiO₇ | PC:DEC = 1:2, LiPF₆ 1 mol/L | 5.0 | 4.0 | 5:4 |
| Example 15 | LiNi_{0.8}Co_{0.1}Mn_{0.1}O₂ | Nb₂TiO₇ | PC:DEC = 1:2, LiPF₆ 1 mol/L | 0.6 | 4.7 | 1:7.8 |
| Example 16 | LiNi_{0.8}Co_{0.1}Mn_{0.1}O₂ | Nb₂TiO₇ | PC:DEC = 1:2, LiPF₆ 1 mol/L | 4.0 | 5.0 | 4:5 |

TABLE 3

| | Positive electrode | Negative electrode | Solvent for nonaqueous | PS initial | DFP initial | PS:DFP initial |
|---|---|---|---|---|---|---|
| | active material | active material | electrolyte, electrolyte salt | concentration | concentration | concentration ratio |
| Example 17 | LiNi_{0.8}Co_{0.1}Mn_{0.1}O₂ | Nb₂TiO₇ | PC:DEC = 1:2, LiPF₆ 1 mol/L | 3.0 | 0.5 | 6:1 |
| Example 18 | LiNi_{0.8}Co_{0.1}Mn_{0.1}O₂ | Nb₂TiO₇ | PC:DEC = 1:2, LiPF₆ 1 mol/L | 5.0 | 0.5 | 10:1 |
| Example 19 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 20 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 21 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 22 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 23 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 24 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 25 | LiNi_{0.8}Co_{0.1}Mn_{0.1}O₂ | Nb₂TiO₇ | PC:DEC = 1:2, LiPF₆ 1 mol/L | 5.0 | 0.5 | 10:1 |
| Example 26 | LiNi_{0.8}Co_{0.1}Mn_{0.1}O₂ | Nb₂TiO₇ | PC:DEC = 1:2, LiPF₆ 1 mol/L | 5.0 | 0.6 | 8.3:1 |
| Example 27 | LiNi_{0.8}Co_{0.1}Mn_{0.1}O₂ | Nb₂TiO₇ | PC:DEC = 1:2, LiPF₆ 1 mol/L | 1.0 | 0.5 | 2:1 |
| Example 28 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 29 | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |

TABLE 4

| | Positive electrode | Negative electrode | Solvent for nonaqueous | PS initial | DFP initial | PS:DFP initial |
|---|---|---|---|---|---|---|
| | active material | active material | electrolyte, electrolyte salt | concentration | concentration | concentration ratio |
| Comparative | LiNi_{0.8}Co_{0.1}Mn_{0.1}O₂ | Nb₂TiO₇ | PC:DEC = 1:2, LiPF₆ 1 mol/L | 0.0 | 1.0 | 0:1 |
| Example 1 | | | | | | |
| Comparative | LiNi_{0.8}Co_{0.1}Mn_{0.1}O₂ | Nb₂TiO₇ | PC:DEC = 1:2, LiPF₆ 1 mol/L | 1.0 | 0.0 | 1:0 |
| Example 2 | | | | | | |
| Comparative | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 3 | | | | | | |
| Comparative | LiNi_{0.8}Co_{0.1}Mn_{0.1}O₂ | Nb₂TiO₇ | PC:DEC = 1:2, LiPF₆ 1 mol/L | 1.0 | 1.0 | 1:1 |
| Example 4 | | | | | | |
| Comparative | LiNi_{0.8}Co_{0.1}Mn_{0.1}O₂ | Nb₂TiO₇ | PC:DEC = 1:2, LiPF₆ 1 mol/L | 4.5 | 0.5 | 9:1 |
| Example 5 | | | | | | |
| Comparative | LiNi_{0.8}Co_{0.1}Mn_{0.1}O₂ | Nb₂TiO₇ | PC:DEC = 1:2, LiPF₆ 1 mol/L | 0.5 | 0.5 | 1:1 |
| Example 6 | | | | | | |
| Comparative | LiNi_{0.8}Co_{0.1}Mn_{0.1}O₂ | Nb₂TiO₇ | PC:DEC = 1:2, LiPF₆ 1 mol/L | 0.5 | 0.1 | 5:1 |
| Example 7 | | | | | | |

TABLE 5

| | Aging | Aging | Electrode drying | Electrode |
|---|---|---|---|---|
| | temperature | time | temperature | drying time |
| | (° C.) | (hour) | (° C.) | (hour) |
| Example 1 | 35 | 35 | 120 | 24 |
| Example 2 | 35 | 35 | 120 | 24 |
| Example 3 | 35 | 35 | 120 | 24 |
| Example 4 | 35 | 35 | 120 | 24 |
| Example 5 | 35 | 35 | 120 | 24 |
| Example 6 | 35 | 35 | 120 | 24 |
| Example 7 | 35 | 35 | 120 | 24 |
| Example 8 | 35 | 35 | 120 | 24 |
| Example 9 | 35 | 35 | 120 | 24 |
| Example 10 | 35 | 35 | 120 | 24 |
| Example 11 | 35 | 35 | 120 | 24 |
| Example 12 | 35 | 35 | 120 | 24 |
| Example 13 | 35 | 35 | 120 | 24 |
| Example 14 | 30 | 30 | 120 | 24 |
| Example 15 | 30 | 30 | 120 | 24 |
| Example 16 | 30 | 30 | 120 | 24 |

TABLE 6

| | Aging | Aging | Electrode drying | Electrode |
|---|---|---|---|---|
| | temperature | time | temperature | drying time |
| | (° C.) | (hour) | (° C.) | (hour) |
| Example 17 | 30 | 30 | 120 | 24 |
| Example 18 | 30 | 30 | 120 | 24 |
| Example 19 | 30 | 35 | 120 | 24 |
| Example 20 | 50 | 35 | 120 | 24 |
| Example 21 | 25 | 35 | 120 | 24 |
| Example 22 | 35 | 30 | 120 | 24 |
| Example 23 | 35 | 48 | 120 | 24 |
| Example 24 | 35 | 20 | 120 | 24 |
| Example 25 | 50 | 48 | 120 | 24 |
| Example 26 | 45 | 40 | 120 | 24 |
| Example 27 | 50 | 48 | 120 | 24 |
| Example 28 | 35 | 35 | 80 | 24 |
| Example 29 | 35 | 35 | 1 | 0 |

TABLE 7

| | Aging | Aging | Electrode drying | Electrode |
|---|---|---|---|---|
| | temperature | time | temperature | drying time |
| | (° C.) | (hour) | (° C.) | (hour) |
| Comparative | 35 | 35 | 120 | 24 |
| Example 1 | | | | |
| Comparative | 35 | 35 | 120 | 24 |
| Example 2 | | | | |
| Comparative | 60 | 35 | 120 | 24 |
| Example 3 | | | | |
| Comparative | 35 | 60 | 120 | 24 |
| Example 4 | | | | |
| Comparative | 50 | 48 | 120 | 24 |
| Example 5 | | | | |
| Comparative | 50 | 48 | 120 | 24 |
| Example 6 | | | | |
| Comparative | 35 | 35 | 120 | 24 |
| Example 7 | | | | |

TABLE 8

| | S content | S content | PS | DFP | | Amount |
|---|---|---|---|---|---|---|
| | per positive | per negative | concentration | concentration | | of gas |
| | electrode | electrode | in nonaqueous | in nonaqueous | Resistance | generated |
| | mixture | mixture | electrolyte | electrolyte | increase | after 90 |
| | layer (g/m³) | layer (g/m³) | (% by mass) | (% by mass) | value | days (mL) |
| Example 1 | 403 | 404 | 0.87 | 0.70 | 1.5 | 3.3 |
| Example 2 | 402 | 402 | 0.87 | 0.69 | 1.5 | 3.0 |
| Example 3 | 403 | 404 | 0.88 | 0.70 | 1.4 | 3.2 |
| Example 4 | 404 | 404 | 0.86 | 0.69 | 1.4 | 3.1 |
| Example 5 | 403 | 405 | 0.85 | 0.71 | 1.5 | 3.3 |
| Example 6 | 402 | 403 | 0.88 | 0.70 | 1.6 | 3.2 |
| Example 7 | 402 | 402 | 0.87 | 0.69 | 1.5 | 3.0 |
| Example 8 | 403 | 404 | 0.88 | 0.70 | 1.4 | 3.2 |
| Example 9 | 404 | 404 | 0.86 | 0.69 | 1.4 | 3.1 |
| Example 10 | 403 | 405 | 0.85 | 0.71 | 1.5 | 3.3 |
| Example 11 | 402 | 404 | 0.88 | 0.70 | 1.4 | 3.1 |
| Example 12 | 403 | 405 | 0.86 | 0.69 | 1.5 | 3.3 |
| Example 13 | 404 | 403 | 0.87 | 0.71 | 1.6 | 3.2 |
| Example 14 | 422 | 421 | 4.70 | 3.60 | 3.7 | 2.2 |
| Example 15 | 390 | 380 | 0.50 | 4.41 | 1.4 | 8.0 |
| Example 16 | 420 | 417 | 3.70 | 4.60 | 3.0 | 2.0 |

TABLE 9

| | S content | S content | PS | DFP | | Amount |
|---|---|---|---|---|---|---|
| | per positive | per negative | concentration | concentration | | of gas |
| | electrode | electrode | in nonaqueous | in nonaqueous | Resistance | generated |
| | mixture | mixture | electrolyte | electrolyte | increase | after 90 |
| | layer (g/m³) | layer (g/m³) | (% by mass) | (% by mass) | value | days (mL) |
| Example 17 | 423 | 430 | 1.80 | 0.25 | 2.7 | 3.0 |
| Example 18 | 430 | 430 | 3.10 | 0.30 | 2.1 | 4.2 |
| Example 19 | 402 | 403 | 0.88 | 0.75 | 1.8 | 3.1 |
| Example 20 | 422 | 429 | 0.50 | 0.60 | 1.9 | 3.2 |
| Example 21 | 399 | 398 | 0.60 | 0.40 | 5.0 | 5.1 |
| Example 22 | 402 | 402 | 0.87 | 0.76 | 1.8 | 3.1 |
| Example 23 | 408 | 407 | 0.70 | 0.65 | 1.9 | 3.4 |
| Example 24 | 402 | 401 | 0.60 | 0.40 | 5.0 | 5.1 |
| Example 25 | 430 | 430 | 3.10 | 0.30 | 2.1 | 4.2 |
| Example 26 | 429 | 435 | 2.90 | 0.50 | 2.0 | 4.3 |
| Example 27 | 402 | 403 | 0.60 | 0.20 | 1.2 | 3.6 |
| Example 28 | 405 | 407 | 0.58 | 0.68 | 2.3 | 5.6 |
| Example 29 | 404 | 403 | 0.80 | 0.79 | 3.0 | 6.5 |

TABLE 10

| | S content | S content | PS | DFP | | Amount |
|---|---|---|---|---|---|---|
| | per positive | per negative | concentration | concentration | | of gas |
| | electrode | electrode | in nonaqueous | in nonaqueous | Resistance | generated |
| | mixture | mixture | electrolyte | electrolyte | increase | after 90 |
| | layer (g/m³) | layer (g/m³) | (% by mass) | (% by mass) | value | days (mL) |
| Comparative | 0 | 0 | 0.00 | 0.80 | 5.0 | 22.0 |
| Example 1 | | | | | | |
| Comparative | 500 | 499 | 0.35 | 0.00 | 1.5 | 14.0 |
| Example 2 | | | | | | |
| Comparative | 480 | 477 | 0.25 | 0.50 | 3.0 | 16.0 |
| Example 3 | | | | | | |
| Comparative | 458 | 457 | 0.39 | 0.42 | 2.0 | 10.0 |
| Example 4 | | | | | | |
| Comparative | 490 | 489 | 2.30 | 0.20 | 6.0 | 3.2 |
| Example 5 | | | | | | |
| Comparative | 441 | 442 | 0.24 | 0.40 | 3.0 | 20.0 |
| Example 6 | | | | | | |
| Comparative | 442 | 443 | 0.26 | 0.06 | 2.5 | 15.0 |
| Example 7 | | | | | | |

The following was found from Tables 2 to 10.

Each of the positive electrodes included in the secondary batteries of Examples 1 to 29 included a positive electrode mixture layer containing sulfur atoms. This is considered to be because a reaction between propanesultone and the positive electrode active material was caused by undergoing the initial charging-discharging and aging, and as a result, sulfur atoms were contained in the positive electrode active material-containing layer.

In Comparative Example 1, which is the same as Example 1 except that the nonaqueous electrolyte did not contain propanesultone, neither the positive electrode mixture layer nor the negative electrode mixture layer contained sulfur atoms. In addition, the resistance increase value was high, and the amount of gas generation was high. This is considered to be because gas generation due to decomposition of the nonaqueous electrolyte was not suppressed because the nonaqueous electrolyte did not contain propanesultone.

In Comparative Example 2, which was the same as Example 1 except that the nonaqueous electrolyte did not contain lithium difluorophosphate, the S content per positive electrode mixture layer was high, and the PS concentration in the nonaqueous electrolyte was low. In addition, the amount of gas generation was high. This is considered to be because the decomposition of propanesultone was not suppressed in the initial charging-discharging and aging. As a result, it is considered that the high-temperature durability was deteriorated.

Comparative Example 3, which was prepared in the same manner as in Example 1 except that the aging temperature was increased, had a high amount of gas generation. This is considered to be because the decomposition of propanesultone excessively proceeded during aging by performing aging at a high temperature of 60° C., so that the S content per positive electrode mixture layer became greater than 430 g/m³, and the PS concentration in the nonaqueous electrolyte became smaller than 0.5% by mass.

Comparative Example 4, which was prepared in the same manner as in Example 1 except that the aging time was lengthened, had a higher resistance increase value and a higher amount of gas generation than in Example 1. This is considered to be because the decomposition of propanesultone excessively proceeded during aging by performing aging for a long time, so that the S content per positive electrode mixture layer was greater than 430 g/m³, and the PS concentration in the nonaqueous electrolyte was smaller than 0.5% by mass.

Comparative Example 5, in which both the S content per positive electrode mixture layer and the S content per negative electrode mixture layer were greater than 430 g/m³, had a high resistance increase value. This is considered to be because as a result of the decomposition of propanesultone, a sulfur-containing phase was excessively formed on the surface of the active material, which caused the resistance increase.

In Comparative Example 6 in which the PS concentration in the nonaqueous electrolyte was less than 0.5% by mass, the amount of gas generation was high. This is considered to be because the propanesultone capable of serving as a sacrificial material did not sufficiently remain in the nonaqueous electrolyte contained in the secondary battery after the post-treatment, so that the reaction in which the nonaqueous electrolyte decomposes to generate gas was not suppressed.

In Comparative Example 7 in which the DFP concentration in the nonaqueous electrolyte was less than 0.2% by mass, the PS concentration in the nonaqueous electrolyte was also less than 0.5% by mass, and the amount of gas generation was high. This is considered to be because the consumption of propanesultone in the initial charging-discharging and aging was not suppressed because lithium difluorophosphate was not sufficiently present in the nonaqueous electrolyte, and as a result, propanesultone capable of serving as a sacrificial material did not sufficiently remain in the nonaqueous electrolyte contained in the secondary battery after the post-treatment.

As shown in Examples 1 to 6, the effect of suppressing gas generation and resistance increase can be obtained even when the positive electrode active material is changed to one different from that in Example 1, such as a lithium-nickel-cobalt-manganese composite oxide having a different ratio of Ni, Co, and Mn, a lithium manganese composite oxide, or a lithium phosphorus oxide having an olivine structure.

As shown in Examples 7 to 10, the effect of suppressing gas generation and resistance increase can be obtained even when the negative electrode active material is changed to one different from that in Example 1, such as lithium titanate having a spinel structure, a carbon material, an orthorhombic titanium composite oxide, or a monoclinic titanium dioxide.

As shown in Examples 11 to 13, the effect of suppressing gas generation and resistance increase can be obtained even when the nonaqueous solvent of the nonaqueous electrolyte is changed to one different from that in Example 1, such as a solvent containing methyl ethyl carbonate, dimethyl carbonate, ethyl propionate, or the like.

As shown in Examples 14 to 18, even when the initial concentrations of PS and DFP in the nonaqueous electrolyte are variously changed, the effect of suppressing gas generation and resistance increase can be obtained.

Comparing Examples 1 and 19 to 21 with Comparative Example 3, the lower the aging temperature, the lower the S content per positive electrode mixture layer tended to be. In Examples 1 and 19 to 21, in which the S content per positive electrode mixture layer was 430 g/m³ or less, the amount of gas generation was lower than that in Comparative Example 3. In addition, comparing Examples 1, 19, and 20 with Comparative Example 3, the higher the aging temperature, the less PS tended to be in the nonaqueous electrolyte.

Comparing Examples 1 and 22 to 24 with Comparative Example 4, the shorter the aging time, the lower the S content per positive electrode mixture layer to be. In Examples 1 and 22 to 24 in which the S content per positive electrode mixture layer was 430 g/m³ or less, the amount of gas generation was lower than that in Comparative Example 4.

Comparing Examples 25 to 26, in Example 25 in which the S content per negative electrode mixture layer was 430 g/m³ or less, the amount of gas generation tended to be lower than that in Example 26 in which the S content per negative electrode mixture layer was greater than 430 g/m³.

Comparing Examples 1 and 15 with Comparative Examples 1 and 6, the higher the PS concentration in the nonaqueous electrolyte, the lower the gas generation tended to be.

Comparing Examples 1, 28, and 29, in Examples 1 and 28 in which the electrode was vacuum-dried, the resistance increase value tended to be lower and the amount of gas generation tended to be smaller than that in Example 29 in which the electrode was not vacuum-dried. Furthermore, in Example 1 in which the electrode was vacuum-dried at 120° C., the resistance increase value tended to be further lower and the amount of gas generation tended to be smaller than those in Example 28 in which the electrode was vacuum-dried at 80° C. This is considered to be due to the fact that the higher the electrode drying temperature and the longer the drying time, the less moisture remains in the electrode. This is considered to be because the less moisture in the electrode, the less likely the propanesultone and lithium difluorophosphate in the nonaqueous electrolyte are consumed, which makes it easier to obtain the effect of suppressing propanesultone consumption by lithium difluorophosphate and the effect of suppressing gas generation by propanesultone even after the initial charging-discharging.

According to at least one of these embodiments or Examples, a secondary battery including a positive electrode, a negative electrode, and a nonaqueous electrolyte is provided. The positive electrode includes a positive electrode mixture layer containing a positive electrode active material and sulfur atoms. The mass of sulfur atoms per unit volume of the positive electrode mixture layer is 430 g/m³ or less. The nonaqueous electrolyte contains propanesultone and lithium difluorophosphate. The concentration of propanesultone in the nonaqueous electrolyte is 0.5% by mass or more. The concentration of lithium difluorophosphate in the nonaqueous electrolyte is 0.2% by mass or more. Therefore, it is possible to provide a secondary battery capable of suppressing the amount of gas generation and resistance increase at a high temperature and achieving excellent life performance even at a high temperature.

Hereinafter, the invention according to the embodiment will be additionally described.

<1> A secondary battery including a positive electrode, a negative electrode, and a nonaqueous electrolyte,
the positive electrode including a positive electrode mixture layer containing a positive electrode active material and sulfur atoms,
a mass of the sulfur atoms per unit volume of the positive electrode mixture layer being 430 g/m³ or less, and
the nonaqueous electrolyte containing propanesultone and lithium difluorophosphate, and
a concentration of the propanesultone in the nonaqueous electrolyte being 0.5% by mass or more, and
a concentration of the lithium difluorophosphate in the nonaqueous electrolyte being 0.2% by mass or more.

<2> The secondary battery according to <1>, in which the negative electrode includes a negative electrode mixture layer containing a negative electrode active material and sulfur atoms.

<3> The secondary battery according to <2>, in which a mass of the sulfur atoms per unit volume of the negative electrode mixture layer is 430 g/m³ or less.

<4> A battery pack including the secondary battery according to any one of <1> to <3>.

<5> The battery pack according to <4>, further including:
an external power distribution terminal; and
a protective circuit.

<6> The battery pack according to <4> or <5>, including a plurality of the secondary battery, in which
the plurality of secondary batteries are electrically connected in series, in parallel, or in a combination of in-series connection and in-parallel connection.

<7> A vehicle including the battery pack according to any one of <4> to <6>.

<8> The vehicle according to <7>, including a mechanism configured to convert kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising a positive electrode, a negative electrode, and a nonaqueous electrolyte,
the positive electrode comprising a positive electrode mixture layer containing a positive electrode active material and sulfur atoms,
a mass of the sulfur atoms per unit volume of the positive electrode mixture layer being 430 g/m³ or less, and
the nonaqueous electrolyte containing propanesultone and lithium difluorophosphate, and
a concentration of the propanesultone in the nonaqueous electrolyte being 0.5% by mass or more, and
a concentration of the lithium difluorophosphate in the nonaqueous electrolyte being 0.2% by mass or more.

2. The secondary battery according to claim 1, wherein the negative electrode comprises a negative electrode mixture layer containing a negative electrode active material and sulfur atoms.

3. The secondary battery according to claim 2, wherein a mass of the sulfur atoms per unit volume of the negative electrode mixture layer is 430 g/m³ or less.

4. A battery pack comprising the secondary battery according to claim 1.

5. The battery pack according to claim 4, further comprising:
an external power distribution terminal; and
a protective circuit.

6. The battery pack according to claim 4, comprising a plurality of the secondary battery, wherein
the plurality of secondary batteries are electrically connected in series, in parallel, or in a combination of in-series connection and in-parallel connection.

7. A vehicle comprising the battery pack according to claim 4.

8. The vehicle according to claim 7, comprising a mechanism configured to convert kinetic energy of the vehicle into regenerative energy.
